(19) United States
(12) Patent Application Publication
(10) Pub. No.: US 2016/0124199 A1
(43) Pub. Date: May 5, 2016

(54) ZOOM LENS AND IMAGE PICKUP APPARATUS INCLUDING THE ZOOM LENS

(71) Applicant: CANON KABUSHIKI KAISHA, Tokyo (JP)

(72) Inventors: Yotaro Sanjo, Utsunomiya-shi (JP); Yutaka Iriyama, Saitama-shi (JP); Tomoya Yamada, Utsunomiya-shi (JP); Masakazu Kodaira, Utsunomiya-shi (JP)

(21) Appl. No.: 14/920,231

(22) Filed: Oct. 22, 2015

(30) Foreign Application Priority Data
Oct. 29, 2014 (JP) 2014-220300

(51) Int. Cl. G02B 15/173; G02B 15/20; G02B 27/00

(52) U.S. Cl. CPC G02B 15/173; G02B 27/0025; G02B 15/20

(57) ABSTRACT

A zoom lens include, from an object side: a positive first unit that does not move for zooming; a negative second unit that moves during zooming; a negative third unit that moves during zooming; a positive fourth unit that moves during zooming; and a positive fifth unit, wherein the second unit moves towards the image side during zooming towards a telephoto end, the third unit moves towards the object side during focus adjustment towards a close distance, and a focal length of the zoom lens at the wide angle end, a zoom ratio, a focal length of the zoom lens at a zoom position where the third unit is closest to the object, a focal length of the first unit, a focal length of the second unit, a focal length of the third unit, and a focal length of the fourth unit are appropriately set.

### BACKGROUND OF THE INVENTION

1. Field of the Invention

The present invention relates to zoom lens and an image pickup apparatus including the zoom lens, and particularly, is suitable for a broadcast TV camera, a movie camera, a video camera, a digital still camera and a silver-halide film camera.

2. Description of the Related Art

In recent years, zoom lens with a wide angle of view, high zoom ratio, reduced size and weight, and high optical performance are demanded for an image pickup apparatus, such as a TV camera, a movie camera, a video camera and a photographic camera. An example of known zoom lens with a wide angle of view and high zoom ratio includes positive-lead type zoom lens including five or more units as a whole, wherein a unit having a positive refractive power that does not move for zooming is arranged closest to the object, as proposed in Japanese Patent No. 2621247 and Japanese Patent Application Laid-Open No. 2011-107693.

Japanese Patent No. 2621247 and Japanese Patent Application Laid-Open No. 2011-107693 propose zoom lens including: a first lens unit having a positive refractive power; a second lens unit having a negative refractive power; a third lens unit having a negative refractive power; a fourth lens unit having a positive refractive power; and a fifth lens unit having a positive refractive power, wherein the third lens unit forms a convex movement locus toward the object in the middle of zooming.

So-called a rear-focus type zoom lens is also proposed, in which the focus adjustment is performed without moving the first lens unit. Japanese Patent Application Laid-Open No. 2005-292605 proposes zoom lens including a first lens unit having a positive refractive power, a second lens unit having a negative refractive power, a third lens unit having a negative refractive power and a fourth lens unit having a positive refractive power, wherein focus adjustment is performed by a part of the fourth lens unit.

To obtain a wide angle of view, high zoom ratio, reduced size and weight, and high optical performance in five-unit zoom lens, it is particularly important to appropriately set a refractive power of the first lens unit, refractive powers of the second, third and fourth lens units that moves during zooming, and movement loci during zooming.

To realize a wider angle of view, higher zoom ratio, and further reduced size and weight in the conventional four-unit zoom lens for TV camera, the refractive powers of the lens units need to be increased, and there is a problem that variations in various aberrations increase.

To particularly reduce the size and weight of the first lens unit, the number of lenses of the first lens unit needs to be reduced, or the refractive power of the first lens unit needs to be increased. Therefore, it is difficult to suppress the variations in various aberrations caused by zooming and focus adjustment.

In Japanese Patent No. 2621247, the third lens unit and the fourth lens unit are moved with different loci during zooming from the wide angle end to the telephoto end to thereby favorably correct the optical performance in the middle of zooming. However, the reduction in the size and weight is not attained.

In Japanese Patent Application Laid-Open No. 2011-107693, the reduction in the size and weight of the first lens unit is particularly attained by defining a movement locus of the third lens unit during zooming, from the wide angle end to the zoom position in the middle.

However, to realize a wide angle of view, high zoom ratio, further reduced size and weight, and high optical performance, it is important to abolish the focus adjustment by the first lens unit, to reduce the number of lenses of the first lens unit, and to appropriately set the refractive powers of the first lens unit and the second to fourth lens units. In this regard, Japanese Patent Application Laid-Open No. 2011-107693 does not define ranges of appropriate refractive powers, particularly refractive powers of the first and third lens units, when the third lens unit adjusts the focus.

In Japanese Patent Application Laid-Open No. 2005-292605, the size and weight of the first lens unit can be reduced by the rear-focus system. However, in the four-unit or five-unit zoom lens often adopted for broadcast or industrial zoom lens in which the lens units on the image side of the aperture stop that do not move for zooming, a detachable focal length conversion optical system is generally arranged in the lens unit for imaging closest to the image. Therefore, when the rear-focus system is adopted, there is a problem of an increased extension amount in focus adjustment at the telephoto side and the object distance close side when the focal length conversion optical system is mounted.

### SUMMARY OF THE INVENTION

In view of the foregoing, an object of the present invention is to provide zoom lens with a wide angle of view, high zoom ratio, reduced size and weight, and high optical performance throughout the entire zoom range in the positive-lead type five-unit zoom lens.

The present invention provides a zoom lens including, from an object side to an image side: a first lens unit having a positive refractive power that does not move for zooming; a second lens unit having a negative refractive power that moves during zooming; a third lens unit having a negative refractive power that moves during zooming; a fourth lens unit having a positive refractive power that moves during zooming; and a fifth lens unit having a positive refractive power, wherein the second lens unit moves from the object side to the image side during zooming from a wide angle end to a telephoto end, the third lens unit moves from the image side to the object side during focus adjustment from infinity to a close distance, and

fw×Z^{0.07}<fz<fw×Z^{0.5}

4.00<|f1/f2|<7.50

2.00≦|f1/f3|<4.00

0.90<|f1/f4|<4.00

are satisfied, where fw represents a focal length of the zoom lens at the wide angle end, Z represents a zoom ratio, fz represents a focal length of the zoom lens at a zoom position where the third lens unit is positioned closest to the object, f1 represents a focal length of the first lens unit, f2 represents a focal length of the second lens unit, f3 represents a focal length of the third lens unit, and f4 represents a focal length of the fourth lens unit.

According to the present invention, zoom lens with a wide angle of view, high zoom ratio, reduced size and weight, and high optical performance throughout the entire zoom range and an image pickup apparatus including the zoom lens can be obtained.

Further features of the present invention will become apparent from the following description of exemplary embodiments with reference to the attached drawings.

### BRIEF DESCRIPTION OF THE DRAWINGS

FIG. 1 is a cross-sectional view of lenses when an infinity object is focused at a wide angle end of zoom lens according to a first numerical embodiment of the present invention.

FIG. 2A is a longitudinal aberration at the wide angle end, at object distance infinity according to the first numerical embodiment.

FIG. 2B is a longitudinal aberration at a focal length of 31.01 mm where a third lens unit is positioned closest to an object, at the object distance infinity according to the first numerical embodiment.

FIG. 2C is a longitudinal aberration at a telephoto end, at the object distance infinity according to the first numerical embodiment.

FIG. 3 is a cross-sectional view of lenses when the infinity object is focused at the wide angle end of the zoom lens according to a second numerical embodiment of the present invention.

FIG. 4A is a longitudinal aberration at the wide angle end, at the object distance infinity according to the second numerical embodiment.

FIG. 4B is a longitudinal aberration at the focal length of 20.98 mm where the third lens unit is positioned closest to the object, at the object distance infinity according to the second numerical embodiment.

FIG. 4C is a longitudinal aberration at the telephoto end, at the object distance infinity according to the second numerical embodiment.

FIG. 5 is a cross-sectional view of lenses when the infinity object is focused at the wide angle end of the zoom lens according to a third numerical embodiment of the present invention.

FIG. 6A is a longitudinal aberration at the wide angle end, at the object distance infinity according to the third numerical embodiment.

FIG. 6B is a longitudinal aberration at the focal length of 11.83 mm where the third lens unit is positioned closest to the object, at the object distance infinity according to the third numerical embodiment.

FIG. 6C is a longitudinal aberration at the telephoto end, at the object distance infinity according to the third numerical embodiment.

FIG. 7 is a cross-sectional view of lenses when the infinity object is focused at the wide angle end of the zoom lens according to a fourth numerical embodiment of the present invention.

FIG. 8A is a longitudinal aberration at the wide angle end, at the object distance infinity according to the fourth numerical embodiment.

FIG. 8B is a longitudinal aberration at the focal distance of 10.89 mm where the third lens unit is positioned closest to the object, at the object distance infinity according to the fourth numerical embodiment.

FIG. 8C is a longitudinal aberration at the telephoto end, at the object distance infinity according to the fourth numerical embodiment.

FIG. 9 is a cross-sectional view of lenses when the infinity object is focused at the wide angle end of the zoom lens according to a fifth numerical embodiment of the present invention.

FIG. 10A is a longitudinal aberration at the wide angle end, at the object distance infinity according to the fifth numerical embodiment.

FIG. 10B is a longitudinal aberration at the focal distance of 33.39 mm where the third lens unit is positioned closest to the object, at the object distance infinity according to the fifth numerical embodiment.

FIG. 10C is a longitudinal aberration at the telephoto end, at the object distance infinity according to the fifth numerical embodiment.

FIG. 11 is a cross-sectional view of lenses when the infinity object is focused at the wide angle end of the zoom lens according to a sixth numerical embodiment of the present invention.

FIG. 12A is a longitudinal aberration at the wide angle end, at the object distance infinity according to the sixth numerical embodiment.

FIG. 12B is a longitudinal aberration at the focal length of 60.78 mm where the third lens unit is positioned closest to the object, at the object distance infinity according to the sixth numerical embodiment.

FIG. 12C is a longitudinal aberration at the telephoto end, at the object distance infinity according to the sixth numerical embodiment.

FIG. 13 is an explanatory diagram of a paraxial arrangement and movement loci of a second lens unit U2, the third lens unit U3 and a fourth lens unit U4 in zooming from the wide angle end to the telephoto end in five-unit zoom lens of the present invention.

FIG. 14 is a schematic diagram of main parts of an image pickup apparatus of the present invention.

### DESCRIPTION OF THE EMBODIMENTS

Preferred embodiments of the present invention will now be described in detail in accordance with the accompanying drawings.

Features of numerical embodiments will be described.

Zoom lens of the present invention include, from an object side to an image side, a first lens unit U1 having a positive refractive power configured not to move for zooming. The zoom lens further include: a second lens unit U2 having a negative refractive power configured to move during zooming; a third lens unit U3 having a negative refractive power configured to move during zooming; a fourth lens unit U4 having a positive refractive power configured to move during zooming; an aperture stop SP; and a fifth lens unit U5 having a positive refractive power configured not to move for zooming. During zooming from a wide angle end to a telephoto end, the second lens unit U2 moves from the object side to the image side. During focus adjustment from infinity to a close distance, the third lens unit U3 moves from the image side to the object side.

The zoom lens of the numerical embodiments of the present invention illustrated below are zoom lens including only five lens units, the first to fifth lens units. However, the present invention is not limited to this. For example, a lens unit having a negative (or positive) refractive power configured to move during zooming may be arranged between the second lens unit and the third lens unit. Other lens units may be arranged between the first lens unit and the second lens unit, between the third lens unit and the fourth lens unit or between the fourth lens unit and the fifth lens unit.

Note that the lens unit arranged closest to the object is the first lens unit U1 in the zoom lens of the present invention, and the lens unit arranged closest to the image is the fifth lens unit U5 in first to sixth numerical embodiments described later, for example. It is desirable that the second lens unit U2 of the present numerical embodiment is adjacent to the first lens unit U1 at the wide angle end. In the numerical embodiments, the third lens unit U3 is moved to the object side during focus adjustment.

The following are satisfied:

fw×Z^{0.07}<fz<fw×Z^{0.5} (1)

4.00<|f1/f2|<7.50 (2)

2.00≦|f1/f3|<4.00 (3)

0.90<|f1/f4|<4.00 (4)

where fw represents a focal length of the zoom lens at the wide angle end, Z represents a zoom ratio (focal length of telephoto end/focal length of wide angle end), fz represents a focal length of the zoom lens at a zoom position where the third lens unit is positioned closest to the object, f1 represents a focal length of the first lens unit, f2 represents a focal length of the second lens unit, f3 represents a focal length of the third lens unit, and f4 represents a focal length of the fourth lens unit.

Four-unit zoom lenses that can easily attain a high zoom ratio are often used for broadcast or industrial zoom lenses. The four-unit zoom lens include, from the object side to the image side: a first lens unit having a positive refractive power configured not to move for zooming; and a second lens unit having a negative refractive power for varying magnification configured to move to the image side during zooming from the wide angle end to the telephoto end. The four-unit zoom lens further include: a third lens unit having a positive or negative refractive power configured to move on an optical axis in conjunction with the movement of the second lens unit to correct image plane variation associated with the varying magnification; and a fourth lens unit having a positive refractive power with an imaging function configured not to move for zooming. In the four-unit zoom lens, the second lens unit needs to be widely moved to the image side to increase the magnification on the wide angle side. Consequently, the space between the first lens unit and the second lens unit increases, and the incident height of an off-axis ray incident on the first lens unit increases. For this reason, the incident height of the off-axis ray incident on the first lens unit is the highest at a zoom position fM that is a little closer to the telephoto side from the wide angle end. The effective diameter of the lenses of the first lens unit, particularly the lenses positioned closer to the object, is determined by the zoom position fM.

In the four-unit zoom lens, the movement locus of the third lens unit during zooming is uniquely determined for image plane correction. Specifically, the third lens unit is configured to move so as to depict a locus convex to the object side and is configured to move closest to the object at a zoom position where the imaging magnification of the second lens unit passes through −1.

On the other hand, when the lens units configured to move during zooming include three lens units as in the present invention, the movement locus of the third lens unit U3 during zooming can be arbitrarily set if the fourth lens unit U4 is configured to correct the image plane variation associated with varying magnification. In the numerical embodiments, the movement loci of the second lens unit U2 and the third lens unit U3 are appropriately set during zooming to reduce the effective diameter of the first lens unit U1 to downsize the zoom lens.

In the zoom lens of the numerical embodiments, the third lens unit U3 moves along a locus in which the third lens unit U3 is positioned closer to the object at the zoom position fM. As the third lens unit U3 moves closer to the object, a magnification increasing effect of the third lens unit U3 can be obtained. The increase in the magnification by the third lens unit U3 reduces a magnification increase sharing value of the second lens unit U2 during zooming, and the amount of movement of the second lens unit U2 can be reduced. As a result, the incident height of the off-axis ray incident on the first lens unit U1 is reduced at the zoom position fM, and the effective diameter of the first lens unit U1 can be reduced. The reduction in the effective diameter of the first lens unit U1 inevitably reduces the lens thickness, and this can reduce the size and weight of the first lens unit U1 dominant in terms of lens mass.

FIG. 13 is an explanatory diagram of a paraxial arrangement in the zoom lens of the present invention and movement loci of the second lens unit U2, the third lens unit U3 and the fourth lens unit U4 in zooming from the wide angle end to the telephoto end. A solid line and an alternate long and short dash line indicate the movement loci of the third lens unit U3 when the focus is adjusted to an infinity object distance and a close object distance, respectively. For reference, dotted lines indicate the movement loci of the second lens unit U2 and the third lens unit U3 of the four-unit zoom lens in which the first lens unit U1 adjusts the focus.

In the zoom lens of the present invention, the amount of movement of the second lens unit U2 at the zoom position fM is decreased, and the amount of movement of the third lens unit U3 is increased, compared to the four-unit zoom lens.

Conditional expression (1) defines a range of the focal length fz of the zoom lens at the zoom position fM where the third lens unit U3 is positioned closest to the object after movement during zooming. Setting the focal length fz at the zoom position fM or near the zoom position fM facilitates the reduction in the size and weight of the first lens unit U1.

If the value is greater than the upper limit of conditional expression (1), the reduction effect of the effective diameter of the first lens unit U1 is reduced, and it is difficult to reduce the size and weight.

If the value is smaller than the lower limit of conditional expression (1), variations in spherical aberration, coma and the like increase during zooming and focus adjustment due to sharp movement on the wide angle side of the third lens unit U3, and it is difficult to suppress the aberrations.

Conditional expression (2) defines a ratio of the focal length of the first lens unit U1 and the focal length of the second lens unit U2. The refractive power of each lens unit is defined by a reciprocal of the focal length of the lens unit.

If the value is greater than the upper limit of conditional expression (2), the refractive power of the second lens unit U2 is too strong relative to the refractive power of the first lens unit U1. The variations in various aberrations increase during zooming, and it is difficult to favorably suppress the variations in various aberrations. The refractive power of the first lens unit U1 is too weak relative to the refractive power of the second lens unit U2. The lens diameter of the first lens unit U1 increases, and it is difficult to reduce the size and weight of the first lens unit U1.

If the value is smaller than the lower limit of conditional expression (2), the refractive power of the second lens unit U2 is too weak relative to the refractive power of the first lens unit U1. The amount of movement of the second lens unit U2 increases during zooming, and it is difficult to attain both of a high zoom ratio and a reduction in the size and weight. The refractive power of the first lens unit U1 is too strong relative to the refractive power of the third lens unit U3. It is difficult to favorably suppress variations in various aberrations, such as lateral chromatic aberration or distortion on the wide angle side and spherical aberration on the telephoto side, generated in the first lens unit U1.

Furthermore, conditional expression (2) can be set as follows.

4.50<|f1/f2|<7.10 (2a)

Conditional expression (3) defines a ratio of the focal length of the first lens unit U1 and the focal length of the third lens unit U3.

If the value is greater than the upper limit of conditional expression (3), the refractive power of the third lens unit U3 is too strong relative to the refractive power of the first lens unit U1. Variations in various aberrations, such as spherical aberration and coma, increase during zooming and focus adjustment, and it is difficult to favorably correct the variations in various aberrations. The refractive power of the first lens unit U1 is too weak relative to the refractive power of the third lens unit U3. The lens diameter of the first lens unit U1 increases, and it is difficult to reduce the size and weight of the first lens unit U1.

If the value is smaller than the lower limit of conditional expression (3), the refractive power of the third lens unit U3 is too weak relative to the refractive power of the first lens unit U1. The amount of movement of the third lens unit U3 increases during zooming, and it is difficult to attain both of a high zoom ratio and a reduction in the size and weight. The refractive power of the first lens unit U1 is too strong relative to the refractive power of the third lens unit U3, and it is difficult to favorably suppress variations in various aberrations, such as lateral chromatic aberration or distortion on the wide angle side and spherical aberration on the telephoto side, generated in the first lens unit U1.

Furthermore, conditional expression (3) can be set as follows.

2.00≦|f1/f3|<3.50 (3a)

Conditional expression (4) defines a ratio of the focal length of the first lens unit U1 and the focal length of the fourth lens unit U4.

If the value is greater than the upper limit of conditional expression (4), the refractive power of the fourth lens unit U4 is too strong relative to the refractive power of the first lens unit U1. Variations in various aberrations, such as spherical aberration and coma, increases during zooming, and it is difficult to favorably correct the variations in various aberrations. The refractive power of the first lens unit U1 is too weak relative to the refractive power of the fourth lens unit U4. The lens diameter of the first lens unit U1 increases, and it is difficult to reduce the size and weight of the first lens unit U1.

If the value is smaller than the lower limit of conditional expression (4), the refractive power of the fourth lens unit U4 is too weak relative to the refractive power of the first lens unit U1. The amount of movement of the fourth lens unit U4 increases during zooming, and it is difficult to attain both of a high zoom ratio and a reduction in the size and weight. The refractive power of the first lens unit U1 is too strong relative to the refractive power of the fourth lens unit U4. It is difficult to favorably suppress variations in various aberrations, such as lateral chromatic aberration or distortion on the wide angle side and spherical aberration on the telephoto side, generated in the first lens unit U1.

Furthermore, conditional expression (4) can be set as follows.

1.30<|f1/f4|<3.50 (4a)

Conditional expressions (1) to (4) are satisfied in the first to sixth numerical embodiments.

In the present invention, the third lens unit U3 configured to move during zooming adjusts the focus as illustrated in FIG. 13. The third lens unit U3 is moved from the image side to the object side to adjust the focus from an infinity object to a short-distance object. The third lens unit U3 is arranged on the object side of a focal length conversion optical system. Therefore, the extension amount in the focus adjustment is not changed by the attachment and detachment of the focal length conversion optical system. The second lens unit U2 having a negative refractive power suppresses object point variation of the third lens unit U3 caused by the variation in the object distance. Therefore, the extension amount of the third lens unit U3 is small. As a result, the lens configuration of the first lens unit U1 can be simplified, and the zoom lens can be reduced in size and weight.

If the focus is to be adjusted by the second lens unit U2, there is a problem that the focus cannot be adjusted at a specific zoom position. On the other hand, the focus can be adjusted by the fourth lens unit U4. However, the lens diameter of the fourth lens unit U4 increases more than the third lens unit U3, and this is disadvantageous in reducing the size and weight of the focus drive unit.

The zoom lens of the numerical embodiments of the present invention satisfies the configurations and the conditional expressions to attain a wide angle of view, high zoom ratio, reduced size and weight, and high optical performance throughout the entire zoom range.

In another embodiment of the present invention, conditional expression (5) defines an imaging magnification at the wide angle end of the second lens unit U2 and the zoom position fz when the infinity object is focused.

0.03<β2z/β2w/Z<0.15 (5)

If the value is greater than the upper limit of conditional expression (5), the magnification increase sharing value of the second lens unit U2 at the zoom position fz increases, and the amount of movement of the second lens unit U2 increases. As a result, the air space between the first lens unit U1 and the second lens unit U2 increases, and the height of the off-axis ray of the first lens unit U1 increases. Therefore, it is difficult to reduce the size and weight of the first lens unit U1.

If the value is smaller than the lower limit of conditional expression (5), the magnification increase sharing value of the second lens unit U2 is excessively small, and the magnification increase sharing value of the third lens unit U3 needs to be excessively increased. As a result, sharp movement of the third lens unit U3 is necessary, and variations, such as spherical aberration and coma, increase during zooming and focus adjustment. It is difficult to favorably suppress the aberration.

Furthermore, conditional expression (5) can be set as follows.

0.05<β2z/β2w/Z<0.12 (5a)

In another embodiment of the present invention, conditional expressions (6) and (7) define average powers of a positive lens and a negative lens of the first lens unit.

1.00<φp×f1<2.00 (6)

−0.90<φ1n×f1<−0.20 (7)

If the value is greater than the upper limit of conditional expression (6) and the lower limit of conditional expression (7), the refractive power of each lens of the first lens unit is too strong. As a result, variations in various aberrations, such as lateral chromatic aberration or distortion on the wide angle side and spherical aberration at the telephoto end, generated in the first lens unit increase, and it is difficult to favorably suppress the aberrations. The thickness of each lens in the first lens unit increases, and it is difficult to reduce the size and weight of the first lens unit.

If the value is greater than the lower limit of conditional expression (6) and the upper limit of conditional expression (7), the refractive power of each lens of the first lens unit is too weak. As a result, the space between the positive lens and the negative lens needs to be increased in order for the first lens unit to have an appropriate refractive power, and it is difficult to reduce the size and weight of the first lens unit.

Furthermore, conditional expressions (6) and (7) can be set as follows.

1.20<φp×f1<1.70 (6a)

−0.80<φ1n×f1<−0.30 (7a)

In another embodiment of the present invention, the number of lenses included in the first lens unit is defined. In the present invention, the first lens unit includes four or five lenses. If the number of lenses is further increased, it is difficult to reduce the size and weight of the first lens unit. On the other hand, if the number of lenses is further decreased, the refractive power of each lens included in the first lens unit is too strong. Therefore, the variations in various aberrations, such as lateral chromatic aberration or distortion on the wide angle side and spherical aberration at the telephoto end, generated in the first lens unit increase, and it is difficult to favorably suppress the aberration.

In another embodiment of the present invention, the aperture stop and the lens units on the image side of the aperture stop do not move for zooming. As a result, a constant f-number can be maintained up to the f-drop point.

In another embodiment of the present invention, the aperture stop is positioned between the fourth lens unit and the fifth lens unit. As a result, a constant f-number can be maintained up to the f-drop point.

In another embodiment of the present invention, an inclination formed at the wide angle end by an axial ray passing through the air space between a first sub lens unit U51 and a second sub lens unit U52 relative to the optical axis is defined.

−3.0°<θ<+3.0° (8)

The unit of θ is degrees (°), an angle formed by a diverging ray relative to the optical axis is +, an angle formed by a converging ray relative to the optical axis is −, and θ is 0.0° in an afocal system.

As a result, favorable optical performance can be attained when a focal length conversion optical system FDC is mounted, and necessary and sufficient back focus can be secured.

If the value is greater than the upper limit of conditional expression (8), the axial ray enters FDC by divergence when the focal length conversion optical system FDC is mounted. The refractive power of each lens included in FDC is too strong, and it is difficult to favorably suppress the aberration.

If the value is smaller than the lower limit of conditional expression (8), the height of the axial ray passing through the second sub lens unit U52 is reduced. Therefore, it is difficult to secure necessary and sufficient back focus.

Furthermore, conditional expression (8) can be set as follows.

−1.0°<θ<+1.0° (8a)

In another embodiment of the present invention, a ratio of an optical effective diameter of a final lens surface of the first sub lens unit U51 and a length of the air space on the optical axis between the first sub lens unit U51 and the second sub lens unit U52 is defined.

0.50<D/EA<3.00 (9)

This can attain both of favorable optical performance when the focal length conversion optical system FDC is mounted and compact full length of the lenses of the focal length conversion optical system FDC.

If the value is greater than the upper limit of conditional expression (9), an air space D is too long relative to an optical effective diameter EA, and it is difficult to reduce the full length of the lenses of the focal length conversion optical system FDC. The optical effective diameter EA is too small relative to the air space D, and an entrance pupil diameter is too small. Therefore, it is difficult to secure a necessary and sufficient aperture ratio.

If the value is smaller than the lower limit of conditional expression (9), the air space D is too short relative to the optical effective diameter EA, and the refractive power of each lens in the focal length conversion optical system FDC is too strong. Therefore, it is difficult to favorably suppress the aberration. The optical effective diameter EA is too large relative to the air space D, and the lens diameter of the fifth lens unit U5 is too large. Therefore, it is difficult to reduce the size and weight and to obtain favorable optical performance with a simple lens configuration.

Furthermore, conditional expression (9) can be set as follows.

0.70<D/EA<2.00 (9a)

In another embodiment of the present invention, favorable ranges of the focal length of the zoom lens at the wide angle end and the zoom ratio are defined.

0.45<fw/φ (10)

7.00<Z (11)

Here, φ denotes a diagonal length of the image size of the image pickup element.

If the value is smaller than the lower limit of conditional expression (10), the angle of view at the wide angle end is excessively wide, and the lens diameter of the first lens unit U1 is determined at the wide angle side. Therefore, advantageous effects of the present invention cannot be obtained.

Furthermore, conditional expression (10) can be set as follows.

0.63<fw/φ<1.50 (10a)

If the value is smaller than the lower limit of conditional expression (11), the size and weight can be reduced with the conventional configuration, and the advantageous effects of the present invention cannot be obtained.

### First Embodiment

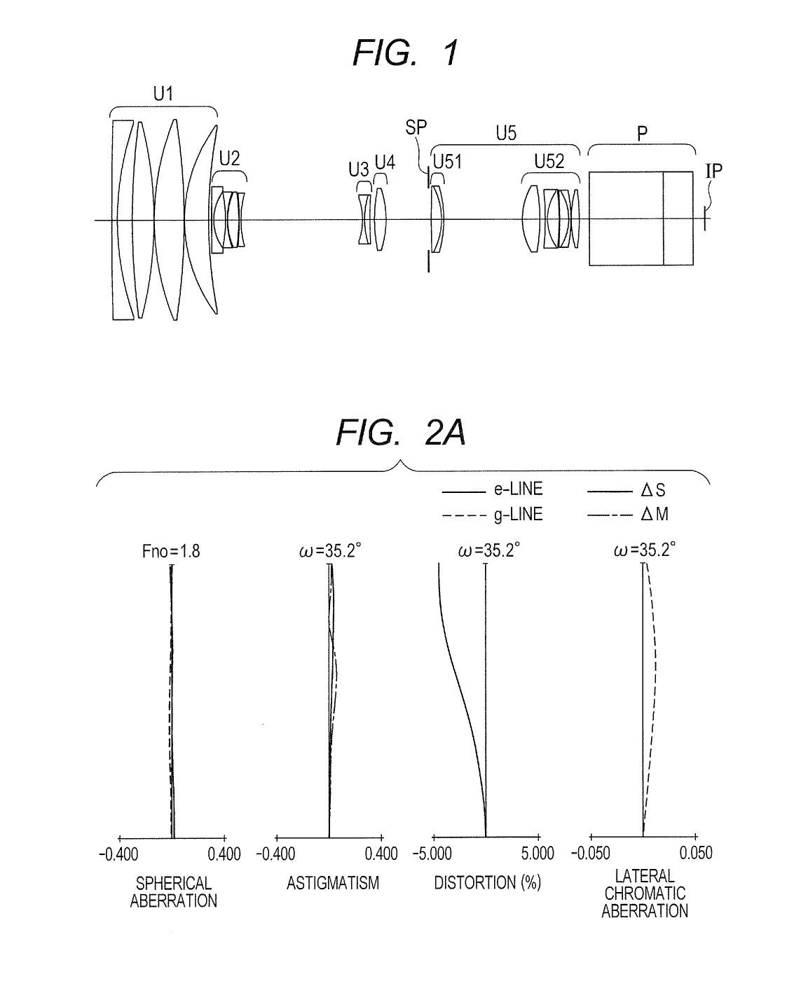

FIG. 1 is a cross-sectional view of lenses when the infinity object is focused at the wide angle end of the zoom lens according to a first numerical embodiment of the present invention. A first lens unit U1 has a positive refractive power configured not to move for zooming. A second lens unit (variator lens unit) U2 has a negative refractive power for varying magnification configured to move to the image side during zooming from the wide angle end (short focal length end) to the telephoto end (long focal length end). A third lens unit (variator lens unit) U3 has a negative refractive power for varying magnification configured to move during zooming from the wide angle end (short focal length end) to the telephoto end (long focal length end). The third lens unit U3 is configured to move to the object side during focusing from the infinity object to the short-distance object. A fourth lens unit (compensator lens unit) U4 has a positive refractive power configured to move in conjunction with the second lens unit U2 and the third lens unit U3 to correct image plane variation associated with varying magnification. SP is an aperture stop. A fifth lens unit U5 has a positive refractive power configured to be immobile during zooming, the fifth lens unit U5 including a first sub lens unit U51 having a positive refractive power and a second sub lens unit U52 having a positive refractive power separated at the largest air space in the unit. A glass block P includes a color separation prism or an optical filter. An image plane IP is equivalent to an image pickup plane of an image pickup element (photoelectric conversion element).

The lens configuration of the units of the first numerical embodiment will be described. The lenses are sequentially arranged from the object side to the image side. The first lens unit U1 includes a negative lens and three positive lenses. The second lens unit U2 includes two negative lenses, a positive lens and a negative lens. The third lens unit U3 includes a cemented lens of a negative lens and a positive lens. The fourth lens unit U4 includes a positive lens. The fifth lens unit U5 includes the aperture stop SP, the first sub lens unit U51 and the second sub lens unit U52. The first sub lens unit U51 includes a cemented lens of a positive lens and a negative lens. The second sub lens unit U52 includes: a positive lens; a cemented lens of a negative lens and a positive lens; a cemented lens of a positive lens and a negative lens; and a positive lens.

Although the aperture stop SP is arranged closest to the object in the fifth lens unit in the present embodiment, the present invention is not limited to this. The advantageous effects of the present invention can also be attained by arranging the aperture stop SP between the second lens unit and the third lens unit, between the third lens unit and the fourth lens unit, or within the fifth lens unit. The same applies to the following second to sixth embodiments as for the position of the aperture stop in the zoom lens.

The zoom lens of the first numerical embodiment is a zoom lens in which the zoom ratio is 21.7, the half angle of view at the wide angle end is 35.2 degrees, and the half angle of view at the telephoto end is 1.9 degrees.

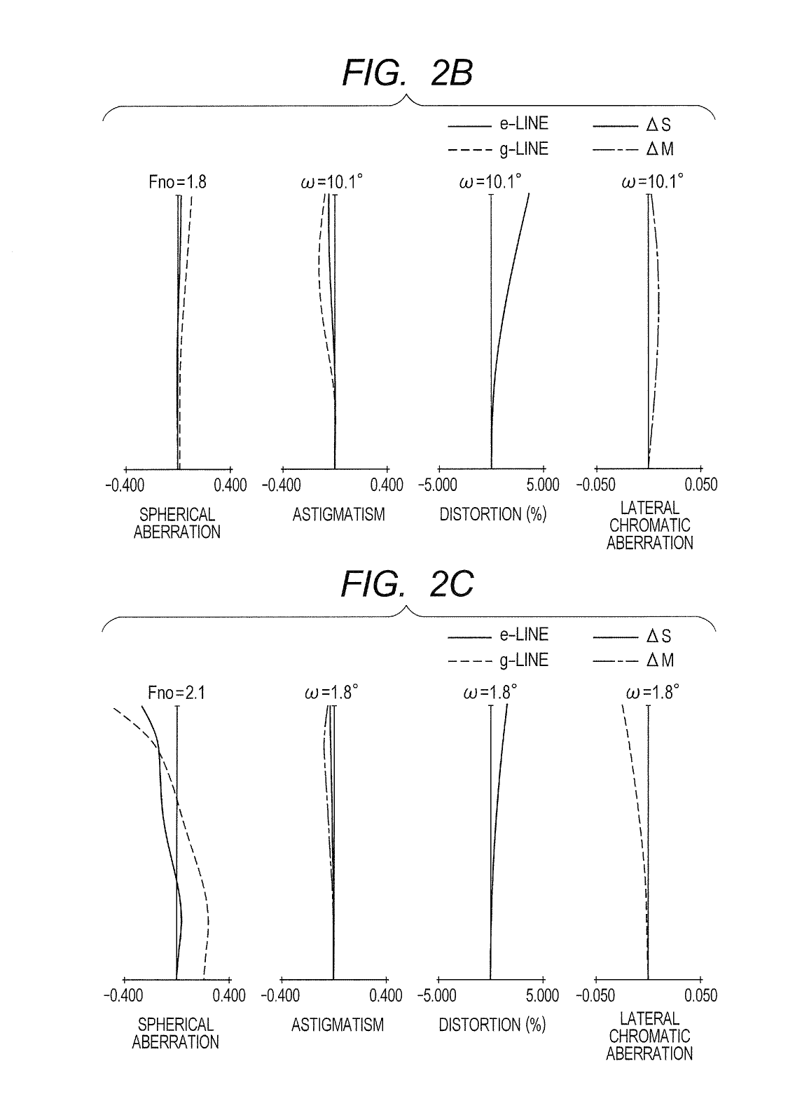

FIGS. 2A, 2B and 2C illustrate longitudinal aberrations at the wide angle end, at the focal length of 31.01 mm where the third lens unit is positioned closest to the object, and at the telephoto end, respectively, at the object distance infinity of the zoom lens according to the first numerical embodiment. The value of the focal length is a value expressing the numerical embodiment described later by mm. The spherical aberration is expressed by an e-line and a g-line. The astigmatism is expressed by a meridional image plane (ΔM) of an e-line and a sagittal image plane (ΔS) of an e-line. The lateral chromatic aberration is expressed by a g-line. The spherical aberration is depicted by a scale of 0.4 mm, the astigmatism is depicted by a scale of 0.4 mm, the distortion is depicted by a scale of 5%, and the lateral chromatic aberration is depicted by a scale of 0.05 mm. Fno is an f-number, and w is a half angle of view. The wide angle end and the telephoto end are zoom positions where the second unit U2 for varying magnification is positioned at both ends of a mechanically movable range on the optical axis. As illustrated in FIGS. 2A, 2B and 2C, the zoom lens of the present embodiment realizes favorable optical performance.

Numerical data of the first numerical embodiment is illustrated. Here, r is a radius of curvature of each surface from the object side, d is a space between the adjacent surfaces, nd and νd are a refractive index and an Abbe number of each optical member.

The aspherical shape is expressed by the following formula, wherein an X axis is in the optical axis direction, an H axis is in the perpendicular direction of the optical axis, the travelling direction of light is positive, R is a paraxial radius of curvature, k is a conic constant, and A3, A4, A5, A6, A7, A8, A9, A10, A11 and A12 are aspherical coefficients.

$$X = \frac{{H}^{2} / R}{1 + \sqrt{1 - ( 1 + k ) {( H / R )}^{2}}} + A 4 {H}^{4} + A 6 {H}^{6} + A 8 {H}^{8} + A 10 {H}^{10} + A 12 {H}^{12} + A 3 {H}^{3} + A 5 {H}^{5} + A 7 {H}^{7} + A 9 {H}^{9} + A 11 {H}^{11}$$

Furthermore, “e−Z” denotes “×10^{-z}”, for example. A mark * indicates an aspherical surface.

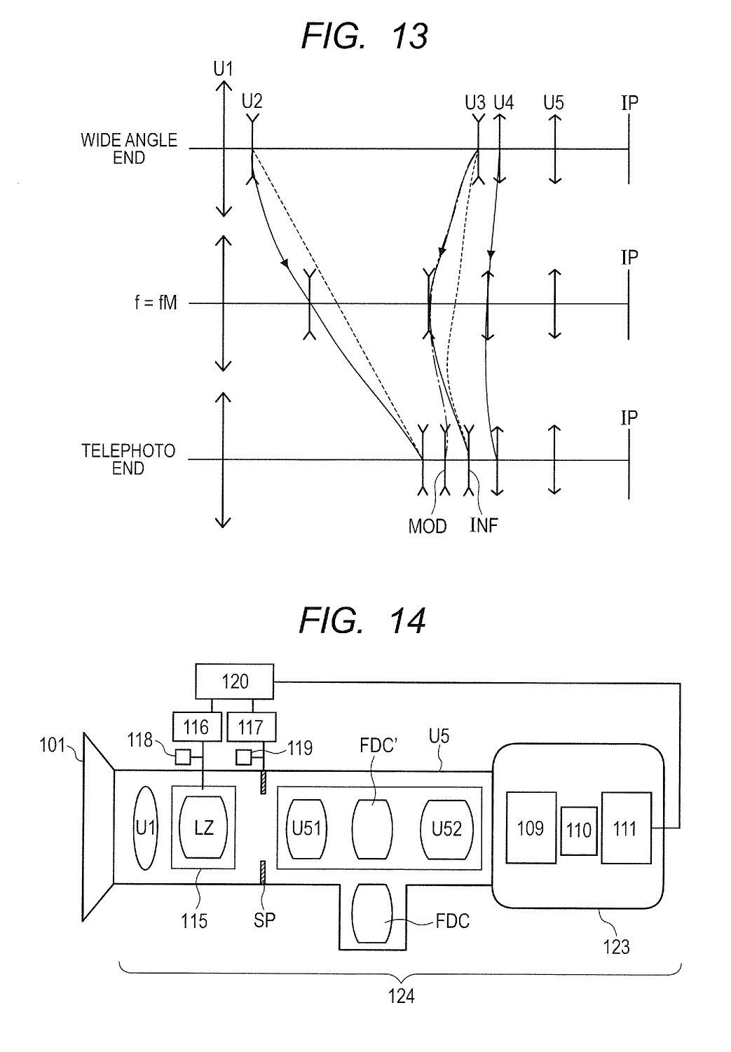

The first numerical embodiment satisfies conditional expressions (1) to (11), and the zoom lens of the present invention attains a wide angle of view, high zoom ratio, reduced size and weight, and high optical performance throughout the entire zoom range. FIG. 14 will be used to describe an outline of an image pickup apparatus (TV camera system) using the zoom lens of the first numerical embodiment as a photographic optical system. FIG. 14 is a schematic diagram of main parts of the image pickup apparatus of the present invention. FIG. 14 illustrates a zoom lens 101 of one of the first to sixth embodiments and a camera 123. The zoom lens 101 can be attached to and detached from the camera 123. An image pickup apparatus 124 is formed by mounting the zoom lens 101 on the camera 123.

The zoom lens 101 includes a first lens unit U1, a varying magnification lens unit LZ, a focal length conversion optical system FDC and a fifth lens unit U5. The varying magnification lens unit LZ includes a focus adjustment lens unit. The varying magnification lens unit LZ includes: a unit configured to move on the optical axis for varying magnification; and a unit configured to move on the optical axis for correcting the image plane variation associated with the varying magnification. The aperture stop SP is included between the varying magnification lens unit LZ and the fifth lens unit U5. The fifth lens unit U5 includes a first sub lens unit U51 configured not to move for zooming, a focal length conversion optical system FDC and a second sub lens unit U52.

A drive mechanism 115 includes a helicoid, a cam and an actuator and drives the varying magnification lens unit LZ in the optical axis direction. Motors 116 and 117 (drive units) electrically drive the drive mechanism 115 and the aperture stop SP. Detectors 118 and 119 are detectors such as encoders, potentiometers or photosensors for detecting the position on the optical axis of the varying magnification lens unit LZ and the stop diameter of the aperture stop SP. In the camera 123, a glass block 109 is equivalent to an optical filter or a color separation prism in the camera 123. An image pickup element (photoelectric conversion element) 110 is a CCD sensor or a CMOS sensor that receives a subject image formed by the zoom lens 101. CPUs 111 and 120 are CPUs that control various drives of the camera 123 and the zoom lens body 101.

In this way, an image pickup apparatus with high optical performance is realized by applying the zoom lens of the present invention to a TV camera. A zoom lens according to the second to sixth numerical embodiments described later can also be applied in the same way, and this can realize an image pickup apparatus with high optical performance having the effects of the present invention.

### Second Embodiment

A lens configuration of units of a zoom lens of a second numerical embodiment will be described.

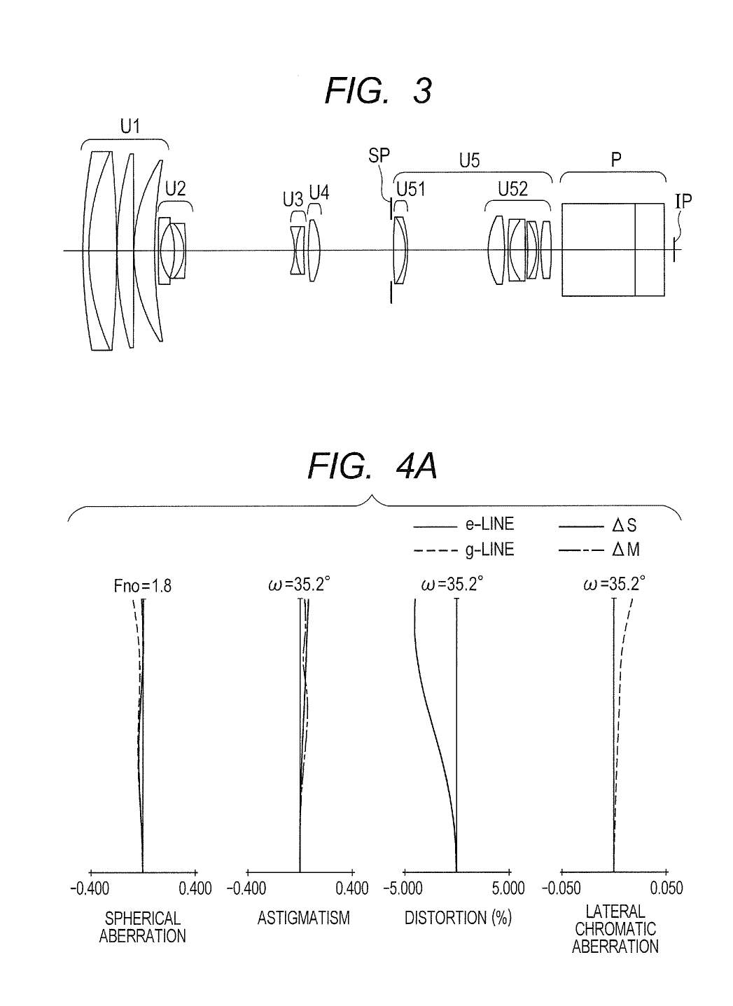

FIG. 3 is a cross-sectional view of lenses when the infinity object is focused at the wide angle end of the zoom lens according to the second numerical embodiment of the present invention. A first lens unit U1 has a positive refractive power configured not to move for zooming. A second lens unit (variator lens unit) U2 has a negative refractive power for varying magnification configured to move to the image side during zooming from the wide angle end (short focal length end) to the telephoto end (long focal length end). A third lens unit (variator lens unit) U3 has a negative refractive power for varying magnification configured to move during zooming from the wide angle end (short focal length end) to the telephoto end (long focal length end). The third lens unit U3 is configured to move to the object side during focusing from the infinity object to the short-distance object. A fourth lens unit (compensator lens unit) U4 has a positive refractive power configured to move in conjunction with the second lens unit U2 and the third lens unit U3 to correct image plane variation associated with varying magnification. SP is an aperture stop. A fifth lens unit U5 has a positive refractive power configured to be immobile during zooming, the fifth lens unit U5 including a first sub lens unit U51 having a positive refractive power and a second sub lens unit U52 having a positive refractive power separated at the largest air space in the unit. A glass block P includes a color separation prism or an optical filter. An image plane IP is equivalent to an image pickup plane of an image pickup element (photoelectric conversion element).

The lens configuration of the units of the second numerical embodiment will be described. The lenses are sequentially arranged from the object side to the image side. The first lens unit U1 includes: a cemented lens of a negative lens and a positive lens; and two positive lenses. The second lens unit U2 includes: a negative lens; and a cemented lens of a positive lens and a negative lens. The third lens unit U3 includes a cemented lens of a negative lens and a positive lens. The fourth lens unit U4 includes a positive lens. The fifth lens unit U5 includes the aperture stop SP, the first sub lens unit U51 and the second sub lens unit U52. The first sub lens unit U51 includes a cemented lens of a positive lens and a negative lens. The second sub lens unit U52 includes: a positive lens; a cemented lens of a negative lens and a positive lens; a cemented lens of a positive lens and a negative lens; and a positive lens.

In the zoom lens of the second numerical embodiment, the zoom ratio is 23.0, the half angle of view at the wide angle end is 35.2 degrees, and the half angle of view at the telephoto end is 1.8 degrees.

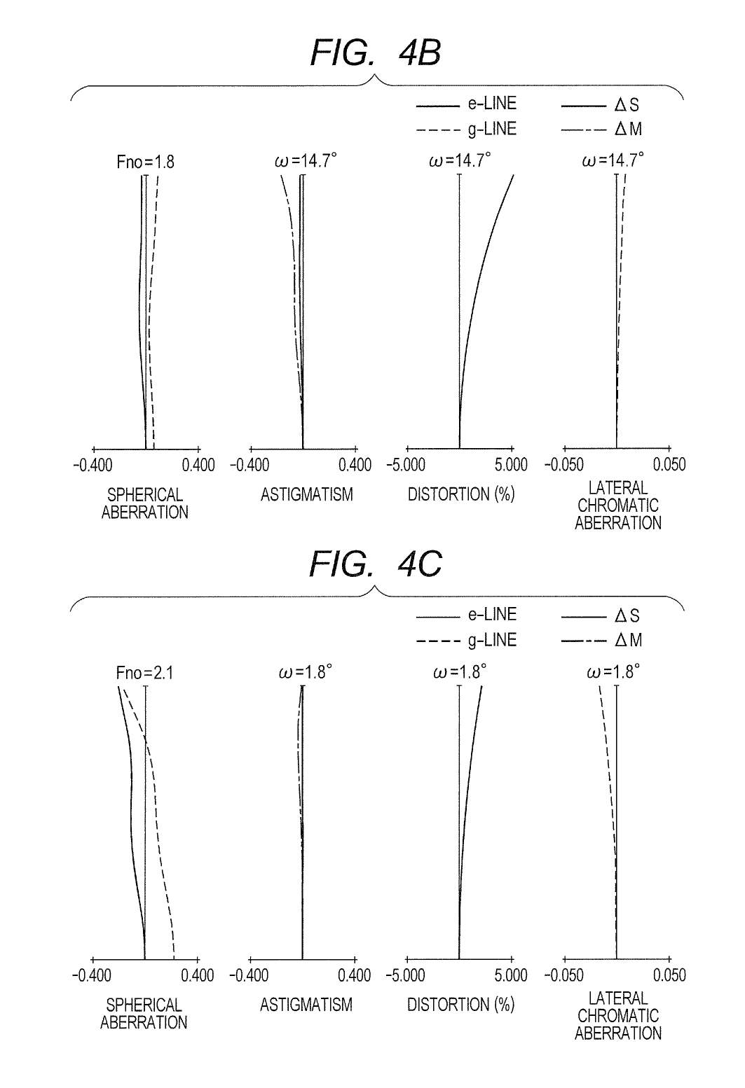

FIGS. 4A, 4B and 4C illustrate longitudinal aberrations at the wide angle end, at the focal length of 20.98 mm where the third lens unit is positioned closest to the object, and at the telephoto end, respectively, at the object distance infinity of the zoom lens according to the second numerical embodiment. The value of the focal length is a value expressing the numerical embodiment described later by mm. The spherical aberration is expressed by an e-line and a g-line. The astigmatism is expressed by a meridional image plane (ΔM) of an e-line and a sagittal image plane (ΔS) of an e-line. The lateral chromatic aberration is expressed by a g-line. The spherical aberration is depicted by a scale of 0.4 mm, the astigmatism is depicted by a scale of 0.4 mm, the distortion is depicted by a scale of 5%, and the lateral chromatic aberration is depicted by a scale of 0.05 mm. Fno is an f-number, and w is a half angle of view. The wide angle end and the telephoto end are zoom positions where the second unit U2 for varying magnification is positioned at both ends of a mechanically movable range on the optical axis. As illustrated in FIGS. 4A, 4B and 4C, the zoom lens of the present embodiment realizes favorable optical performance.

Numerical data of the second numerical embodiment is illustrated. The second numerical embodiment satisfies conditional expressions (1) to (11), and the zoom lens of the present invention attains a wide angle of view, high zoom ratio, reduced size and weight, and high optical performance throughout the entire zoom range.

### Third Embodiment

A lens configuration of units of a zoom lens of a third numerical embodiment will be described.

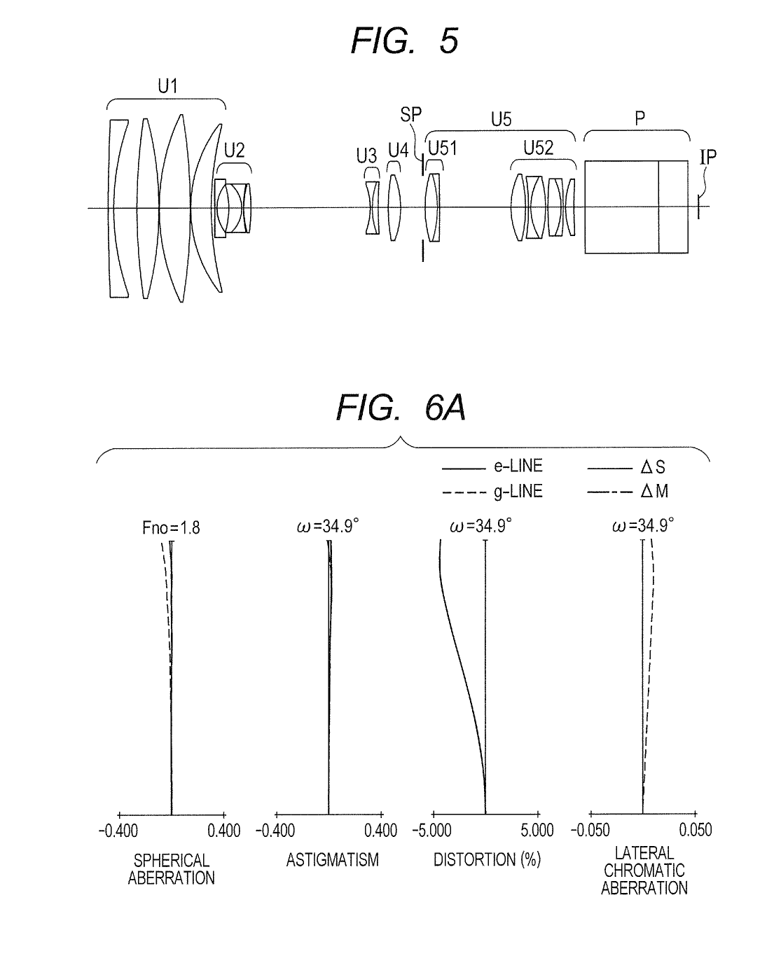

FIG. 5 is a cross-sectional view of lenses when the infinity object is focused at the wide angle end of the zoom lens according to the third numerical embodiment of the present invention. A first lens unit U1 has a positive refractive power configured not to move for zooming. A second lens unit (variator lens unit) U2 has a negative refractive power for varying magnification configured to move to the image side during zooming from the wide angle end (short focal length end) to the telephoto end (long focal length end). A third lens unit (variator lens unit) U3 has a negative refractive power for varying magnification configured to move during zooming from the wide angle end (short focal length end) to the telephoto end (long focal length end). The third lens unit U3 is configured to move to the object side during focusing from the infinity object to the short-distance object. A fourth lens unit (compensator lens unit) U4 has a positive refractive power configured to move in conjunction with the second lens unit U2 and the third lens unit U3 to correct image plane variation associated with varying magnification. SP is an aperture stop. A fifth lens unit U5 has a positive refractive power configured to be immobile during zooming, the fifth lens unit U5 including a first sub lens unit U51 having a positive refractive power and a second sub lens unit U52 having a positive refractive power separated at the largest air space in the unit. A glass block P includes a color separation prism or an optical filter. An image plane IP is equivalent to an image pickup plane of an image pickup element (photoelectric conversion element).

The lens configuration of the units of the third numerical embodiment will be described. The lenses are sequentially arranged from the object side to the image side. The first lens unit U1 includes a negative lens and three positive lenses. The second lens unit U2 includes: a negative lens; a cemented lens of a positive lens and a negative lens; and a positive lens. The third lens unit U3 includes a cemented lens of a negative lens and a positive lens. The fourth lens unit U4 includes a positive lens. The fifth lens unit U5 includes the aperture stop SP, the first sub lens unit U51 and the second sub lens unit U52. The first sub lens unit U51 includes a cemented lens of a positive lens and a negative lens. The second sub lens unit U52 includes: a positive lens; a cemented lens of a negative lens and a positive lens; a cemented lens of a positive lens and a negative lens; and a positive lens.

In the zoom lens of the third numerical embodiment, the zoom ratio is 21.5, the half angle of view at the wide angle end is 34.9 degrees, and the half angle of view at the telephoto end is 1.9 degrees.

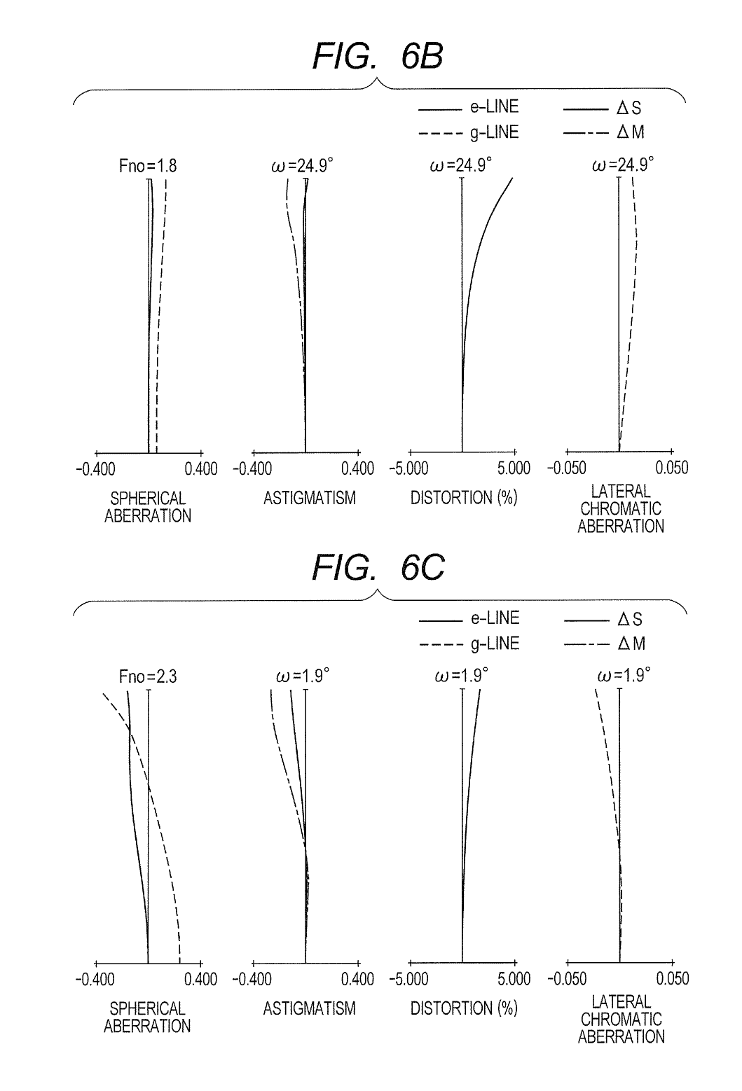

FIGS. 6A, 6B and 6C illustrate longitudinal aberrations at the wide angle end, at the focal length of 11.83 mm where the third lens unit is positioned closest to the object, and at the telephoto end, respectively, at the object distance infinity of the zoom lens according to the third numerical embodiment. The value of the focal length is a value expressing the numerical embodiment described later by mm. In the aberration of the third numerical embodiment, the spherical aberration is expressed by an e-line and a g-line. The astigmatism is expressed by a meridional image plane (ΔM) of an e-line and a sagittal image plane (ΔS) of an e-line. The lateral chromatic aberration is expressed by a g-line. The spherical aberration is depicted by a scale of 0.4 mm, the astigmatism is depicted by a scale of 0.4 mm, the distortion is depicted by a scale of 5%, and the lateral chromatic aberration is depicted by a scale of 0.05 mm. Fno is an f-number, and w is a half angle of view. The wide angle end and the telephoto end are zoom positions where the second unit U2 for varying magnification is positioned at both ends of a mechanically movable range on the optical axis. As illustrated in FIGS. 6A, 6B and 6C, the zoom lens of the present embodiment realizes favorable optical performance.

Numerical data of the third numerical embodiment is illustrated. The third numerical embodiment satisfies conditional expressions (1) to (11), and the zoom lens of the present invention attains a wide angle of view, high zoom ratio, reduced size and weight, and high optical performance throughout the entire zoom range.

### Fourth Embodiment

A lens configuration of units of a zoom lens of a fourth numerical embodiment will be described.

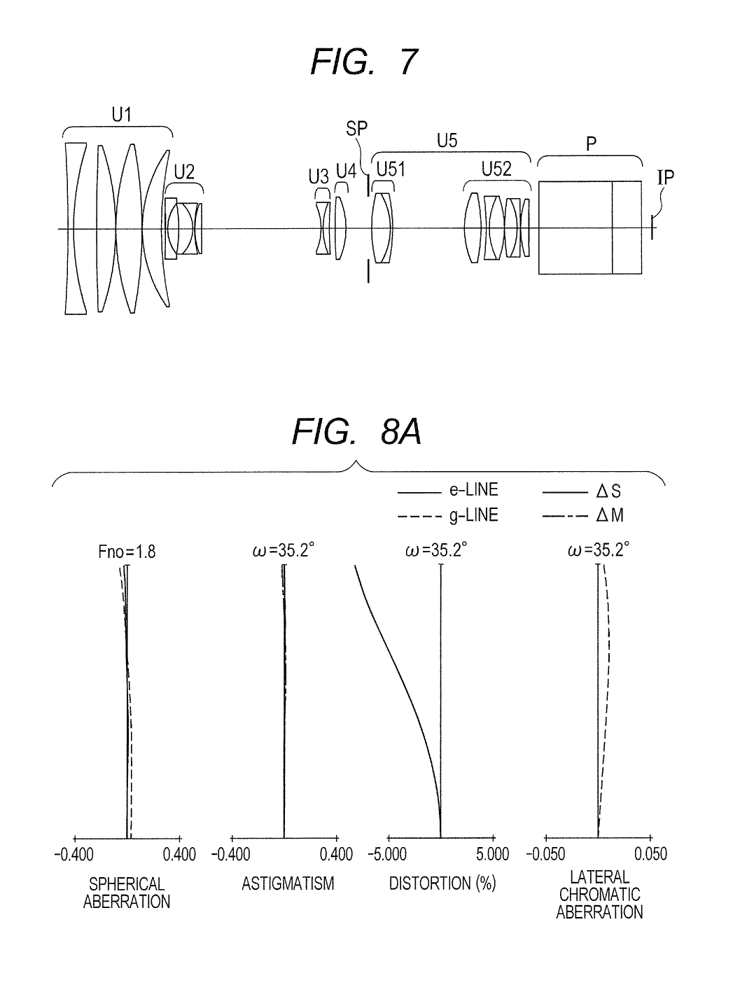

FIG. 7 is a cross-sectional view of lenses when the infinity object is focused at the wide angle end of the zoom lens according to the fourth numerical embodiment of the present invention. A first lens unit U1 has a positive refractive power configured not to move for zooming. A second lens unit (variator lens unit) U2 has a negative refractive power for varying magnification configured to move to the image side during zooming from the wide angle end (short focal length end) to the telephoto end (long focal length end). A third lens unit (variator lens unit) U3 has a negative refractive power for varying magnification configured to move during zooming from the wide angle end (short focal length end) to the telephoto end (long focal length end). The third lens unit U3 is configured to move to the object side during focusing from the infinity object to the short-distance object. A fourth lens unit (compensator lens unit) U4 has a positive refractive power configured to move in conjunction with the second lens unit U2 and the third lens unit U3 to correct image plane variation associated with varying magnification. SP is an aperture stop. A fifth lens unit U5 has a positive refractive power configured to be immobile during zooming, the fifth lens unit U5 including a first sub lens unit U51 having a positive refractive power and a second sub lens unit U52 having a positive refractive power separated at the largest air space in the unit. A glass block P includes a color separation prism or an optical filter. An image plane IP is equivalent to an image pickup plane of an image pickup element (photoelectric conversion element).

The lens configuration of the units of the fourth numerical embodiment will be described. The lenses are sequentially arranged from the object side to the image side. The first lens unit U1 includes a negative lens and three positive lenses. The second lens unit U2 includes: a negative lens; a cemented lens of a positive lens and a negative lens; and a positive lens. The third lens unit U3 includes a cemented lens of a negative lens and a positive lens. The fourth lens unit U4 includes a positive lens. The fifth lens unit U5 includes the aperture stop SP, the first sub lens unit U51 and the second sub lens unit U52. The first sub lens unit U51 includes a cemented lens of a positive lens and a negative lens. The second sub lens unit U52 includes: a positive lens; a cemented lens of a negative lens and a positive lens; a cemented lens of a positive lens and a negative lens; and a positive lens.

In the zoom lens of the fourth numerical embodiment, the zoom ratio is 17.9, the half angle of view at the wide angle end is 35.2 degrees, and the half angle of view at the telephoto end is 2.3 degrees.

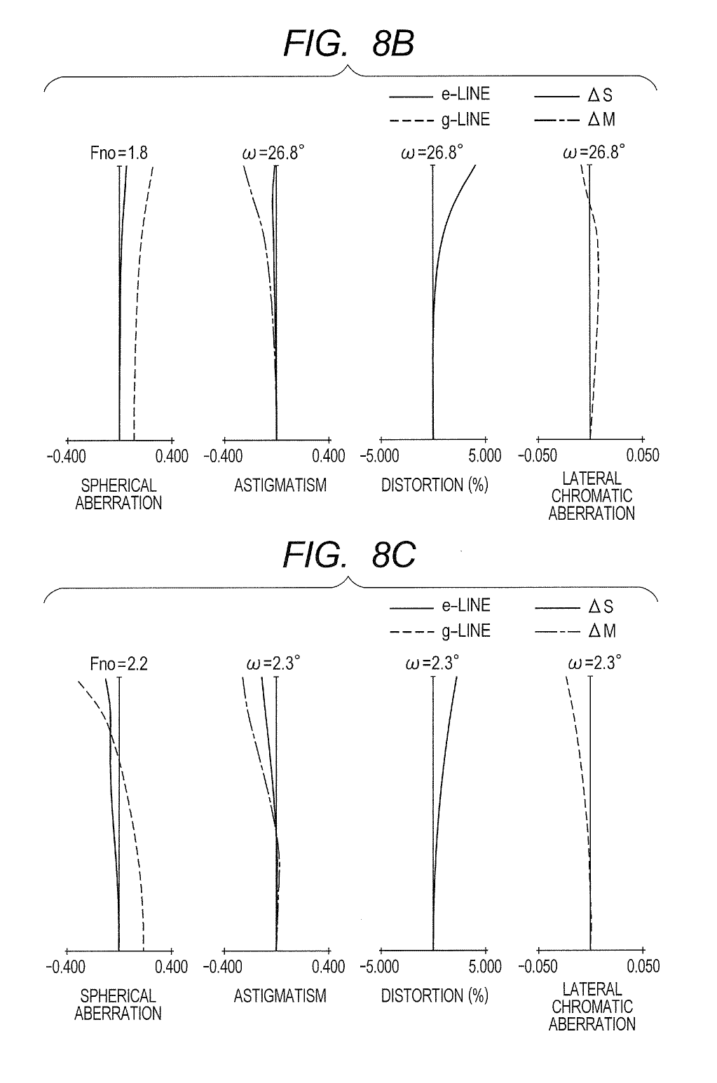

FIGS. 8A, 8B and 8C illustrate longitudinal aberrations at the wide angle end, at the focal length of 10.89 mm where the third lens unit is positioned closest to the object, and at the telephoto end, at the object distance infinity of the zoom lens according to the fourth numerical embodiment. The value of the focal length is a value expressing the numerical embodiment described later by mm. The spherical aberration is expressed by an e-line and a g-line. The astigmatism is expressed by a meridional image plane (ΔM) of an e-line and a sagittal image plane (ΔS) of an e-line. The lateral chromatic aberration is expressed by a g-line. The spherical aberration is depicted by a scale of 0.4 mm, the astigmatism is depicted by a scale of 0.4 mm, the distortion is depicted by a scale of 5%, and the lateral chromatic aberration is depicted by a scale of 0.05 mm. Fno is an f-number, and w is a half angle of view. The wide angle end and the telephoto end are zoom positions where the second unit U2 for varying magnification is positioned at both ends of a mechanically movable range on the optical axis. As illustrated in FIGS. 8A, 8B and 8C, the zoom lens of the present embodiment realize favorable optical performance.

Numerical data of the fourth numerical embodiment is illustrated. The fourth numerical embodiment satisfies conditional expressions (1) to (11), and the zoom lens of the present invention attains a wide angle of view, high zoom ratio, reduced size and weight, and high optical performance throughout the entire zoom range.

### Fifth Embodiment

A lens configuration of units of zoom lens of a fifth numerical embodiment will be described.

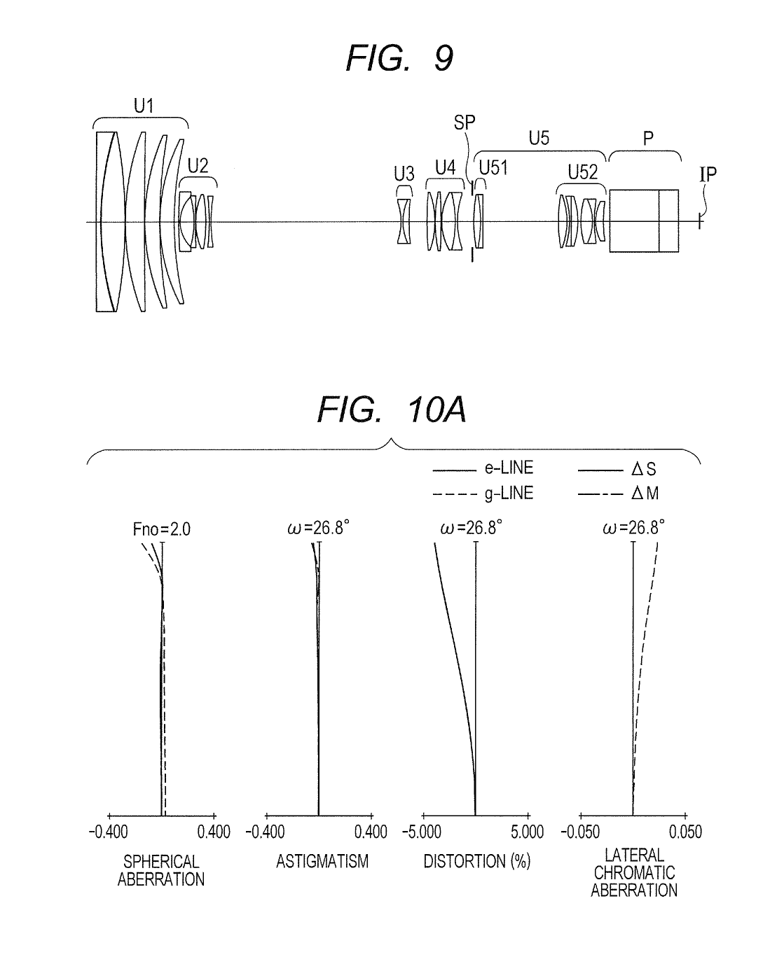

FIG. 9 is a cross-sectional view of lenses when the infinity object is focused at the wide angle end of the zoom lens according to the fifth numerical embodiment of the present invention. A first lens unit U1 has a positive refractive power configured not to move for zooming. A second lens unit (variator lens unit) U2 has a negative refractive power for varying magnification configured to move to the image side during zooming from the wide angle end (short focal length end) to the telephoto end (long focal length end). A third lens unit (variator lens unit) U3 has a negative refractive power for varying magnification configured to move during zooming from the wide angle end (short focal length end) to the telephoto end (long focal length end). The third lens unit U3 is configured to move to the object side during focusing from the infinity object to the short-distance object. A fourth lens unit (compensator lens unit) U4 has a positive refractive power configured to move in conjunction with the second lens unit U2 and the third lens unit U3 to correct image plane variation associated with varying magnification. SP is an aperture stop. A fifth lens unit U5 has a positive refractive power configured to be immobile during zooming, the fifth lens unit U5 including a first sub lens unit U51 having a positive refractive power and a second sub lens unit U52 having a positive refractive power separated at the largest air space in the unit. A glass block P includes a color separation prism or an optical filter. An image plane IP is equivalent to an image pickup plane of an image pickup element (photoelectric conversion element).

The lens configuration of the units of the fifth numerical embodiment will be described. The lenses are sequentially arranged from the object side to the image side. The first lens unit U1 includes a negative lens and four positive lenses. The second lens unit U2 includes two negative lenses, a positive lens and a negative lens. The third lens unit U3 includes a cemented lens of a negative lens and a positive lens. The fourth lens unit U4 includes: two positive lenses; and a cemented lens of a positive lens and a negative lens. The fifth lens unit U5 includes the aperture stop SP, the first sub lens unit U51 and the second sub lens unit U52. The first sub lens unit U51 includes a cemented lens of a positive lens and a negative lens. The second sub lens unit U52 includes: a positive lens; a cemented lens of a negative lens and a positive lens; a cemented lens of a positive lens and a negative lens; and a positive lens.

In the zoom lens of the fifth numerical embodiment, the zoom ratio is 37.2, the half angle of view at the wide angle end is 26.8 degrees, and the half angle of view at the telephoto end is 0.8 degrees.

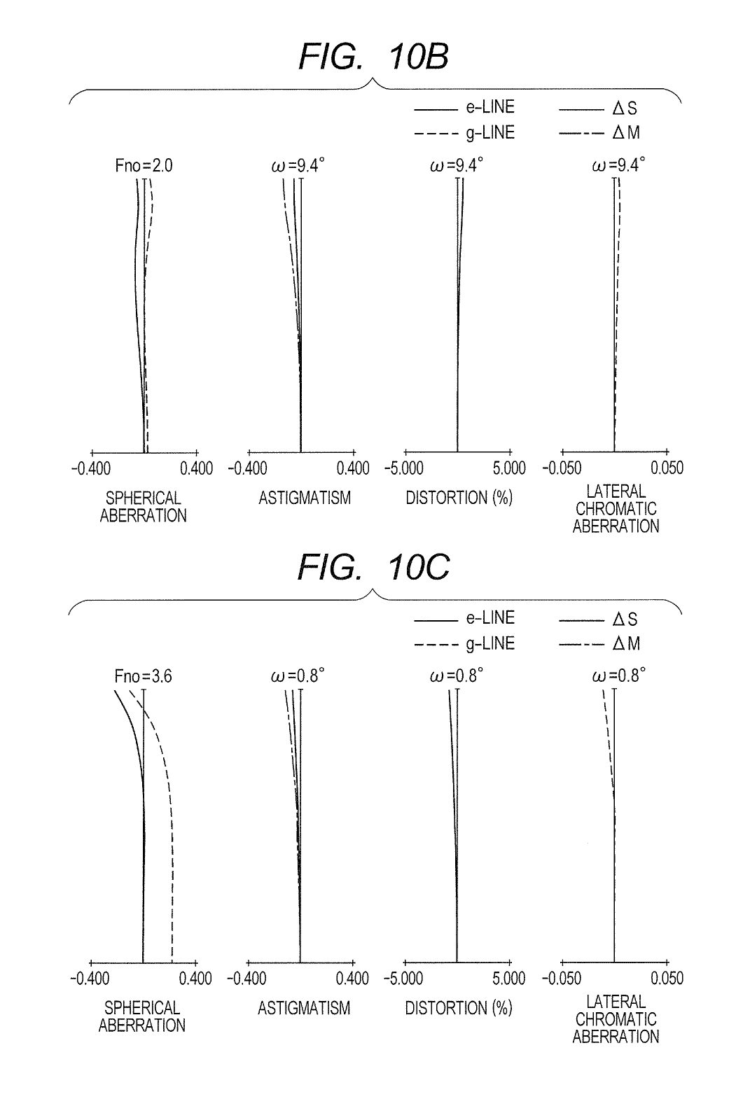

FIGS. 10A, 10B and 10C illustrate longitudinal aberrations at the wide angle end, at the focal length of 33.39 mm where the third lens unit is positioned closest to the object, and at the telephoto end, respectively, at the object distance infinity of the zoom lens according to the fifth numerical embodiment. The value of the focal length is a value expressing the numerical embodiment described later by mm. The spherical aberration is expressed by an e-line and a g-line. The astigmatism is expressed by a meridional image plane (ΔM) of an e-line and a sagittal image plane (ΔS) of an e-line. The lateral chromatic aberration is expressed by a g-line. The spherical aberration is depicted by a scale of 0.4 mm, the astigmatism is depicted by a scale of 0.4 mm, the distortion is depicted by a scale of 5%, and the lateral chromatic aberration is depicted by a scale of 0.05 mm. Fno is an f-number, and w is a half angle of view. The wide angle end and the telephoto end are zoom positions where the second unit U2 for varying magnification is positioned at both ends of a mechanically movable range on the optical axis. As illustrated in FIGS. 10A, 10B and 10C, the zoom lens of the present embodiment realizes favorable optical performance.

Numerical data of the fifth numerical embodiment is illustrated. The fifth numerical embodiment satisfies conditional expressions (1) to (11), and the zoom lens of the present invention attains a wide angle of view, high zoom ratio, reduced size and weight, and high optical performance throughout the entire zoom range.

### Sixth Embodiment

A lens configuration of units of a zoom lens of a sixth numerical embodiment will be described.

The sixth numerical embodiment provides a zoom lens including a focal length conversion optical system FDC between the first sub lens unit U51 and the second sub lens unit U52 of the first numerical embodiment. The focal length conversion optical system FDC is an optical system that can be inserted to and removed from an optical path and that converts the focal length of the entire zoom lens.

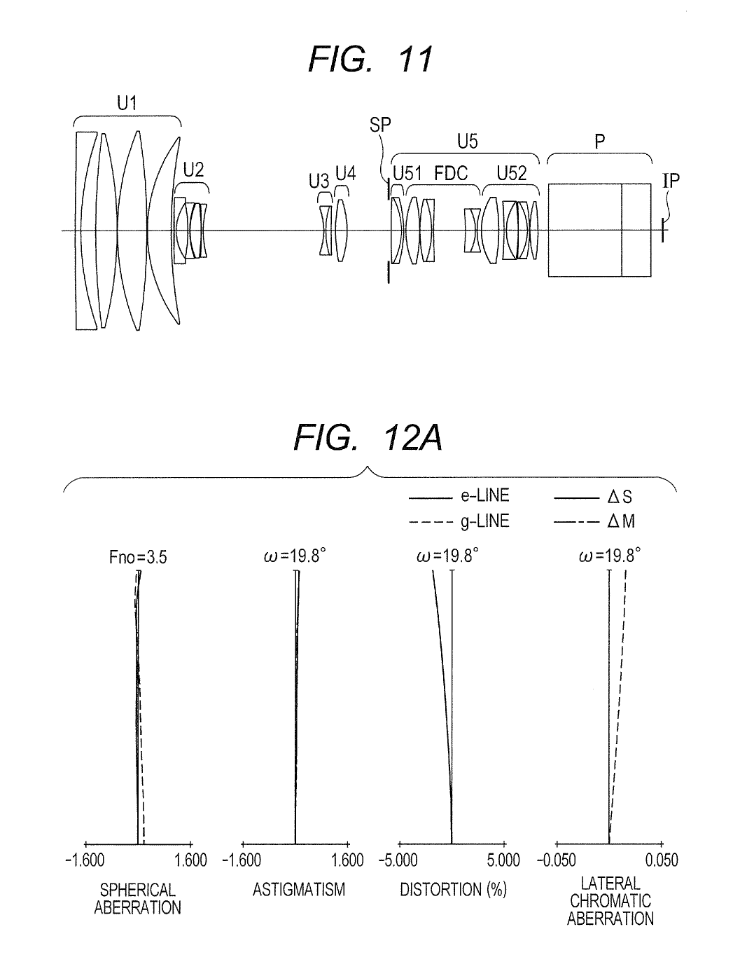

FIG. 11 is a cross-sectional view of lenses when the infinity object is focused at the wide angle end of the zoom lens according to the sixth numerical embodiment of the present invention. A first lens unit U1 has a positive refractive power configured not to move for zooming. A second lens unit (variator lens unit) U2 has a negative refractive power for varying magnification configured to move to the image side during zooming from the wide angle end (short focal length end) to the telephoto end (long focal length end). A third lens unit (variator lens unit) U3 has a negative refractive power for varying magnification configured to move during zooming from the wide angle end (short focal length end) to the telephoto end (long focal length end). The third lens unit U3 is configured to move to the object side during focusing from the infinity object to the short-distance object. A fourth lens unit (compensator lens unit) U4 has a positive refractive power configured to move in conjunction with the second lens unit U2 and the third lens unit U3 to correct image plane variation associated with varying magnification. SP is an aperture stop. A fifth lens unit U5 includes: a first sub lens unit 51 having a positive refractive power configured not to move for zooming; a focal length conversion optical system FDC; and a second sub lens unit U52 having a positive refractive power configured not to move for zooming. A glass block P includes a color separation prism or an optical filter. An image plane IP is equivalent to an image pickup plane of an image pickup element (photoelectric conversion element).

The lens configuration of the units of the sixth numerical embodiment will be described. The lenses are sequentially arranged from the object side to the image side. The first lens unit U1 includes a negative lens and three positive lenses. The second lens unit U2 includes two negative lenses, a positive lens and a negative lens. The third lens unit U3 includes a cemented lens of a negative lens and a positive lens. The fourth lens unit U4 includes a positive lens. The fifth lens unit U5 includes the aperture stop SP, the first sub lens unit U51, the focal length conversion optical system FDC and the second sub lens unit U52. The first sub lens unit U51 includes a cemented lens of a positive lens and a negative lens. The focal length conversion optical system FDC includes: a positive lens; a cemented lens of a positive lens and a negative lens; and a cemented lens of a negative lens and a positive lens. The second sub lens unit U52 includes: a positive lens; a cemented lens of a negative lens and a positive lens; a cemented lens of a positive lens and a negative lens; and a positive lens.

In the zoom lens of the sixth numerical embodiment, the zoom ratio is 21.7, the half angle of view at the wide angle end is 19.8 degrees, and the half angle of view at the telephoto end is 1.0 degree.

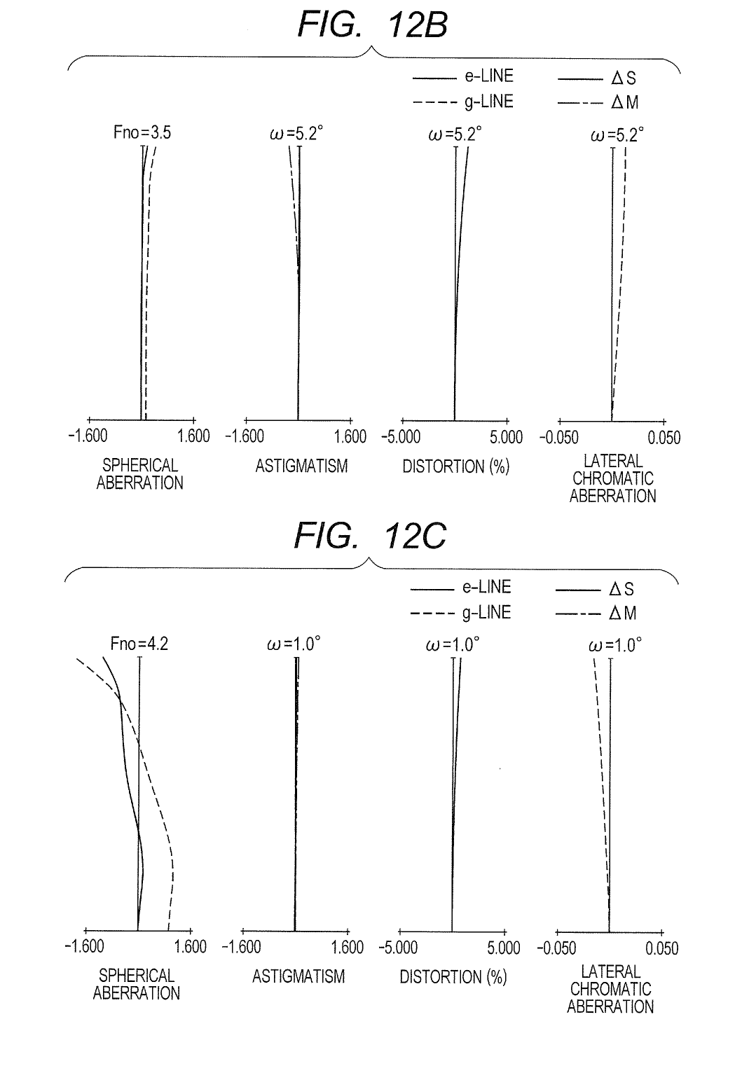

FIGS. 12A, 12B and 12C illustrate longitudinal aberrations at the wide angle end, at the focal length of 60.78 mm where the third lens unit is positioned closest to the object, and at the telephoto end, at the object distance infinity according to the sixth numerical embodiment. The value of the focal length is a value expressing the numerical embodiment described later by mm. The spherical aberration is expressed by an e-line and a g-line. The astigmatism is expressed by a meridional image plane (ΔM) of an e-line and a sagittal image plane (ΔS) of an e-line. The lateral chromatic aberration is expressed by a g-line. The spherical aberration is depicted by a scale of 1.6 mm, the astigmatism is depicted by a scale of 1.6 mm, the distortion is depicted by a scale of 5%, and the lateral chromatic aberration is depicted by a scale of 0.05 mm. Fno is an f-number, and w is a half angle of view. The wide angle end and the telephoto end are zoom positions where the second unit U2 for varying magnification is positioned at both ends of a mechanically movable range on the optical axis. As illustrated in FIGS. 12A, 12B and 12C, the zoom lens of the present embodiment realizes favorable optical performance.

Numerical data of the sixth numerical embodiment is illustrated. The sixth numerical embodiment satisfies conditional expressions (1) to (7), (10) and (11), and the zoom lens of the present invention attains a wide angle of view, high zoom ratio, reduced size and weight, and high optical performance throughout the entire zoom range.

### First Numerical Embodiment

Surface Data

| Surface | | | | | Effective | Focal |
|---|---|---|---|---|---|---|
| Number | r | d | nd | vd | Diameter | Length |
| 1 | 1920.690 | 2.50 | 1.85478 | 24.8 | 85.04 | −160.32 |
| 2 | 128.970 | 6.64 | 1 | | 81.94 | |
| 3 | 332.528 | 9.70 | 1.43387 | 95.1 | 82.85 | 262.69 |
| 4 | −172.530 | 0.10 | 1 | | 83.38 | |
| 5 | 116.994 | 13.35 | 1.43387 | 95.1 | 85.64 | 192.40 |
| 6 | −283.772 | 0.10 | 1 | | 85.40 | |
| 7 | 69.002 | 10.72 | 1.76385 | 48.5 | 80.32 | 128.14 |
| 8 | 215.580 | (Variable) | 1 | | 79.17 | |
| 9* | 1578.603 | 1.00 | 2.00330 | 28.3 | 28.23 | −21.35 |
| 10 | 21.296 | 5.26 | 1 | | 23.84 | |
| 11 | −62.662 | 0.80 | 1.88300 | 40.8 | 23.53 | −25.72 |
| 12 | 36.152 | 0.14 | 1 | | 23.03 | |
| 13 | 31.208 | 4.95 | 1.95906 | 17.5 | 23.21 | 24.43 |
| 14 | −91.496 | 0.18 | 1 | | 22.78 | |
| 15 | −160.517 | 0.80 | 1.77250 | 49.6 | 22.42 | −44.41 |
| 16 | 43.996 | (Variable) | 1 | | 21.60 | |
| 17 | −28.909 | 0.90 | 1.75700 | 47.8 | 18.32 | −21.26 |
| 18 | 37.193 | 2.37 | 1.84666 | 23.8 | 20.06 | 50.77 |
| 19 | 252.136 | (Variable) | 1 | | 20.54 | |
| 20* | 59.789 | 5.20 | 1.64000 | 60.1 | 25.36 | 39.89 |
| 21 | −43.329 | | 1 | | 26.06 | |
| 22 | ∞ | 1.00 | 1 | | 27.12 | |
| (Stop) | | | | | | |
| 23 | 416.688 | 4.65 | 1.50137 | 56.4 | 27.34 | 57.26 |
| 24 | −30.854 | 1.00 | 1.83481 | 42.7 | 27.45 | −92.99 |
| 25 | −51.774 | 35.00 | 1 | | 28.04 | |
| 26 | 28.774 | 7.82 | 1.48749 | 70.2 | 28.08 | 44.15 |
| 27 | −78.838 | 2.38 | 1 | | 27.01 | |
| 28 | −141.385 | 1.00 | 1.88300 | 40.8 | 24.75 | −20.98 |
| 29 | 21.535 | 5.30 | 1.49700 | 81.5 | 23.32 | 36.18 |
| 30 | −101.786 | 0.10 | 1 | | 23.27 | |
| 31 | −275.321 | 4.11 | 1.51742 | 52.4 | 23.20 | 48.18 |
| 32 | −23.069 | 1.00 | 1.80100 | 35.0 | 23.31 | −47.19 |
| 33 | −59.718 | 0.10 | 1 | | 24.05 | |
| 34 | 47.660 | 3.62 | 1.56732 | 42.8 | 24.43 | 55.01 |
| 35 | −89.352 | 4.50 | 1 | | 24.30 | |
| 36 | ∞ | 33.00 | 1.60859 | 46.4 | 40.00 | |
| 37 | ∞ | 13.20 | 1.51633 | 64.1 | 40.00 | |
| 38 | ∞ | | 1 | | 40.00 | |
| Image | ∞ | | | | | |
| Plane | | | | | | |

Aspherical Data
Ninth Surface

| | | |
|---|---|---|
| K = −3.62925e+005 | A4 = 8.70252e−006 | A6 = −9.32479e−008 |
| A8 = 8.34598e−010 | A10 = −2.80575e−012 | A12 = 8.60704e−015 |
| A3 = −4.22396e−007 | A5 = 1.69179e−008 | A7 = −1.69005e−009 |
| A9 = 8.82958e−012 | A11 = −1.08793e−013 | |

Twentieth Surface

| | | |
|---|---|---|
| K = −2.19003e+000 | A4 = −5.55750e−006 | A6 = −4.88314e−009 |
| A8 = 1.46178e−010 | A10 = −8.99732e−013 | A12 = 1.90485e−015 |

Various Data
Zoom Ratio 21.78

| | Wide Angle | Middle | Telephoto |
|---|---|---|---|
| Focal Length | 7.80 | 31.01 | 169.86 |
| F-number | 1.80 | 1.80 | 2.14 |
| Half Angle of View | 35.19 | 10.06 | 1.85 |
| Image Height | 5.50 | 5.50 | 5.50 |
| Full Length of Lens | 264.27 | 264.27 | 264.27 |
| BF | 5.27 | 5.27 | 5.27 |
| d8 | 1.28 | 39.61 | 63.10 |
| d16 | 54.15 | 5.27 | 11.41 |
| d19 | 2.00 | 9.45 | 1.00 |
| d21 | 19.07 | 22.18 | 1.00 |

Focus Adjustment Variable Spacing Close Distance (0.9 m from surface
of first lens unit closest to object)

| | | | |
|---|---|---|---|
| d16 | 54.11 | 4.54 | 3.83 |
| d19 | 2.03 | 10.17 | 8.57 |
| Entrance Pupil Position | 48.56 | 180.67 | 872.34 |
| Exit Pupil Position | 1971.07 | 1971.07 | 1971.07 |
| Front Principal Point | 56.39 | 212.16 | 1056.88 |
| Position | | | |
| Rear Principal Point | −2.53 | −25.73 | −164.59 |
| Position | | | |

Zoom Lens Unit Data

| | | | | Front | |
|---|---|---|---|---|---|
| | | | Lens | Principal | |
| | Start | Focal | Configuration | Point | Rear Principal |
| Unit | Surface | Length | Length | Position | Point Position |
| 1 | 1 | 85.00 | 43.11 | 24.97 | −3.02 |
| 2 | 9 | −13.67 | 13.13 | 2.47 | −6.23 |
| 3 | 17 | −36.65 | 3.27 | 0.17 | −1.60 |
| 4 | 20 | 39.89 | 5.20 | 1.87 | −1.36 |
| 5 | 22 | ∞ | 0.00 | 0.00 | 0.00 |
| 6 | 23 | 151.56 | 5.65 | 3.87 | 0.23 |
| 7 | 26 | 48.97 | 76.13 | 10.38 | −43.68 |

### Second Numerical Embodiment

Surface Data

| Surface | | | | | Effective | Focal |
|---|---|---|---|---|---|---|
| Number | r | d | nd | vd | Diameter | Length |
| 1 | 247.754 | 2.60 | 1.85478 | 24.8 | 86.06 | −221.24 |
| 2 | 107.299 | 12.65 | 1.43875 | 94.9 | 84.59 | 198.85 |
| 3 | −456.072 | 0.10 | 1 | | 84.59 | |
| 4 | 162.993 | 7.56 | 1.43387 | 95.1 | 83.92 | 369.99 |
| 5 | −12533.280 | 0.10 | 1 | | 83.48 | |
| 6 | 76.276 | 9.30 | 1.76385 | 48.5 | 79.79 | 146.12 |
| 7 | 225.793 | (Variable) | 1 | | 78.75 | |
| 8* | 26017.009 | 1.00 | 2.00330 | 28.3 | 28.47 | −19.88 |
| 9 | 20.096 | 6.27 | 1 | | 23.67 | |
| 10 | −36.486 | 4.24 | 1.95906 | 17.5 | 23.35 | 34.89 |
| 11 | −18.581 | 0.80 | 1.88300 | 40.8 | 23.42 | −23.82 |
| 12 | −155.700 | (Variable) | 1 | | 23.26 | |
| 13 | −27.080 | 0.70 | 1.75700 | 47.8 | 17.40 | −17.76 |
| 14 | 27.267 | 3.46 | 1.84666 | 23.8 | 19.21 | 37.29 |
| 15 | 177.277 | (Variable) | 1 | | 20.00 | |
| 16* | 87.620 | 5.28 | 1.64000 | 60.1 | 25.32 | 40.06 |
| 17 | −35.587 | (Variable) | 1 | | 26.16 | |
| 18 | ∞ | 1.00 | 1 | | 27.51 | |
| (Stop) | | | | | | |
| 19 | 202.988 | 5.39 | 1.50137 | 56.4 | 27.79 | 49.32 |
| 20 | −28.043 | 1.00 | 1.83481 | 42.7 | 27.89 | −74.62 |
| 21 | −51.600 | 36.00 | 1 | | 28.61 | |
| 22 | 32.577 | 7.43 | 1.48749 | 70.2 | 29.14 | 51.30 |
| 23 | −101.043 | 1.45 | 1 | | 28.21 | |
| 24 | 155.623 | 1.00 | 1.88300 | 40.8 | 26.31 | −28.18 |
| 25 | 21.498 | 6.97 | 1.49700 | 81.5 | 24.55 | 41.79 |
| 26 | −597.006 | 1.00 | 1 | | 24.03 | |
| 27 | −241.868 | 4.03 | 1.51742 | 52.4 | 23.79 | 51.29 |
| 28 | −24.150 | 1.00 | 1.80100 | 35.0 | 23.77 | −53.06 |
| 29 | −56.466 | 1.00 | 1 | | 24.31 | |
| 30 | 73.604 | 4.69 | 1.56732 | 42.8 | 24.29 | 76.64 |
| 31 | −105.187 | 4.50 | 1 | | 23.91 | |
| 32 | ∞ | 33.00 | 1.60859 | | 46.4 | 40.00 |
| 33 | ∞ | 13.20 | 1.51633 | | 64.1 | 40.00 |
| 34 | ∞ | | 1 | | | 40.00 |
| Image | ∞ | | | | | |
| Plane | | | | | | |

Aspherical Data
Eighth Surface

| | | |
|---|---|---|
| K = 3.00837e+006 | A4 = 7.01451e−006 | A6 = −3.39525e−008 |
| A8 = 4.03442e−010 | A10 = −1.26012e−012 | A12 = 6.42089e−015 |
| A3 = −4.22396e−007 | A5 = 1.69179e−008 | A7 = −1.69005e−009 |
| A9 = 8.82958e−012 | A11 = −1.08793e−013 | |

Sixteenth Surface

| | | |
|---|---|---|
| K = −1.78296e+001 | A4 = −1.22766e−006 | A6 = −3.69373e−008 |
| A8 = 5.21613e−010 | A10 = −3.04182e−012 | A12 = 6.43703e−015 |

Various Data
Zoom Ratio 23.00

| | Wide Angle | Middle | Telephoto |
|---|---|---|---|
| Focal Length | 7.80 | 20.98 | 179.41 |
| F-number | 1.80 | 1.80 | 2.14 |
| Half Angle of View | 35.19 | 14.69 | 1.76 |
| Image Height | 5.50 | 5.50 | 5.50 |
| Full Length of Lens | 265.63 | 265.63 | 265.63 |
| BF | 4.50 | 4.50 | 4.50 |
| d7 | 1.76 | 34.15 | 72.18 |
| d12 | 48.54 | 9.88 | 9.13 |
| d15 | 2.00 | 7.38 | 2.08 |
| d17 | 32.10 | 32.97 | 1.00 |

Focus Adjustment Variable Spacing Close Distance (0.9 m from surface
of first lens unit closest to object)

| | | | |
|---|---|---|---|
| d12 | 48.49 | 9.53 | 2.00 |
| d15 | 2.04 | 7.72 | 9.21 |
| Entrance Pupil Position | 44.24 | 136.46 | 1074.46 |
| Exit Pupil Position | 1612.75 | 1612.75 | 1612.75 |
| Front Principal Point | 52.07 | 157.71 | 1273.88 |
| Position | | | |
| Rear Principal Point | −3.30 | −16.48 | −174.91 |
| Position | | | |

Zoom Lens Unit Data

| | | | | Front | |
|---|---|---|---|---|---|
| | | | Lens | Principal | |
| | Start | Focal | Configuration | Point | Rear Principal |
| Unit | Surface | Length | Length | Position | Point Position |
| 1 | 1 | 100.00 | 32.32 | 12.14 | −8.71 |
| 2 | 8 | −14.32 | 12.31 | 1.57 | −7.62 |
| 3 | 13 | −33.68 | 4.16 | 0.32 | −1.92 |
| 4 | 16 | 40.06 | 5.28 | 2.33 | −0.94 |
| 5 | 18 | ∞ | 0.00 | 0.00 | 0.00 |
| 6 | 19 | 146.77 | 6.39 | 3.61 | −0.56 |
| 7 | 22 | 50.37 | 79.28 | 10.64 | −45.80 |

### Third Numerical Embodiment

Surface Data

| Surface | | | | | Effective | Focal |
|---|---|---|---|---|---|---|
| Number | r | d | nd | vd | Diameter | Length |
| 1 | 843.506 | 2.50 | 1.85478 | 24.8 | 78.03 | −155.48 |
| 2 | 115.595 | 10.46 | | | 75.44 | |
| 3 | 272.717 | 9.95 | 1.43387 | 95.1 | 78.85 | 230.78 |
| 4 | −157.091 | 0.10 | 1 | | 79.33 | |
| 5 | 96.609 | 14.08 | 1.43387 | 95.1 | 80.99 | 163.40 |
| 6 | −256.989 | 0.10 | 1 | | 80.60 | |
| 7 | 61.027 | 9.31 | 1.76385 | 48.5 | 73.82 | 131.21 |
| 8 | 144.609 | (Variable) | 1 | | 72.53 | |
| 9* | −766.073 | 1.00 | 2.00330 | 28.3 | 24.81 | −16.66 |
| 10 | 17.242 | 5.32 | 1 | | 20.64 | |
| 11 | −38.204 | 5.90 | 1.92286 | 18.9 | 20.41 | 22.20 |
| 12 | −14.444 | 0.80 | 1.88300 | 40.8 | 20.55 | −12.93 |
| 13 | 57.451 | 0.10 | 1 | | 20.53 | |
| 14 | 40.243 | 3.23 | 1.61293 | 37.0 | 20.70 | 43.82 |
| 15 | −79.814 | (Variable) | 1 | | 20.69 | |
| 16 | −29.318 | 0.90 | 1.75700 | 47.8 | 19.74 | −20.73 |
| 17 | 34.564 | 2.71 | 1.84666 | 23.8 | 21.71 | 46.44 |
| 18 | 257.123 | (Variable) | 1 | | 22.18 | |
| 19* | 67.450 | 5.68 | 1.64000 | 60.1 | 27.19 | 40.31 |
| 20 | −40.654 | (Variable) | 1 | | 27.88 | |
| 21 (Stop) | ∞ | 1.00 | 1 | | 28.48 | |
| 22 | 52.889 | 5.58 | 1.50137 | 56.4 | 28.81 | 52.16 |
| 23 | −50.315 | 1.00 | 1.83481 | 42.7 | 28.64 | −65.14 |
| 24 | −635.655 | 32.00 | 1 | | 28.68 | |
| 25 | 34.745 | 6.62 | 1.48749 | 70.2 | 28.31 | 46.17 |
| 26 | −60.498 | 1.34 | 1 | | 27.72 | |
| 27 | −91.278 | 1.00 | 1.88300 | 40.8 | 26.26 | −23.02 |
| 28 | 26.483 | 6.73 | 1.49700 | 81.5 | 25.14 | 36.12 |
| 29 | −51.475 | 1.00 | 1 | | 25.14 | |
| 30 | 128.535 | 6.00 | 1.51742 | 52.4 | 24.32 | 47.38 |
| 31 | −29.979 | 1.00 | 1.80100 | 35.0 | 23.61 | −47.68 |
| 32 | −138.119 | 1.00 | 1 | | 23.75 | |
| 33 | 34.600 | 3.78 | 1.56732 | 42.8 | 23.83 | 72.63 |
| 34 | 201.496 | 4.50 | 1 | | 23.33 | |
| 35 | ∞ | 33.00 | 1.60859 | 46.4 | 40.00 | |
| 36 | ∞ | 13.20 | 1.51633 | 64.1 | 40.00 | |
| 37 | ∞ | | 1 | | 40.00 | |
| Image | ∞ | | | | | |
| Plane | | | | | | |

Aspherical Data
Ninth Surface

| | | |
|---|---|---|
| K = 1.22791e+002 | A4 = 6.81422e−006 | A6 = −1.66922e−008 |
| A8 = 1.12445e−010 | A10 = −6.76371e−014 | A12 = 4.72711e−015 |
| A3 = −4.22396e−007 | A5 = 1.69179e−008 | A7 = −1.69005e−009 |
| A9 = 8.82958e−012 | A11 = −1.08793e−013 | |

Nineteenth Surface

| | | |
|---|---|---|
| K = −5.95588e+000 | A4 = −2.88348e−006 | A6 = 4.49140e−010 |
| A8 = 2.53029e−011 | A10 = −1.65395e−013 | A12 = 3.29015e−016 |

Various Data
Zoom Ratio 21.50

| | Wide Angle | Middle | Telephoto |
|---|---|---|---|
| Focal Length | 7.90 | 11.83 | 169.86 |
| F-number | 1.80 | 1.80 | 2.32 |
| Angle of View | 34.85 | 24.94 | 1.85 |
| Half Angle of View | 5.50 | 5.50 | 5.50 |
| Full Length of Lens | 265.10 | 265.10 | 265.10 |
| BF | 4.82 | 4.82 | 4.82 |
| d8 | 1.59 | 12.57 | 56.47 |
| d15 | 53.37 | 27.54 | 10.92 |
| d18 | 4.43 | 7.27 | 1.00 |
| d20 | 10.00 | 22.02 | 1.00 |

Focus Adjustment Variable Spacing Close Distance (0.9 m from surface
of first lens unit closest to object)

| | | | |
|---|---|---|---|
| d12 | 53.33 | 27.44 | 3.03 |
| d15 | 4.47 | 7.36 | 8.88 |
| Entrance Pupil Position | 49.04 | 69.96 | 844.61 |
| Exit Pupil Position | −2808.57 | −2808.57 | −2808.57 |
| Front Principal Point | 56.92 | 81.74 | 1004.21 |
| Position | | | |
| Rear Principal Point | −3.08 | −7.01 | −165.04 |
| Position | | | |

Zoom Lens Unit Data

| | | | | Front | |
|---|---|---|---|---|---|
| | | | Lens | Principal | |
| | Start | Focal | Configuration | Point | Rear Principal |
| Unit | Surface | Length | Length | Position | Point Position |
| 1 | 1 | 75.00 | 46.50 | 28.34 | −2.31 |
| 2 | 9 | −13.67 | 16.35 | 0.65 | −11.26 |
| 3 | 16 | −37.50 | 3.61 | 0.19 | −1.77 |
| 4 | 19 | 40.31 | 5.68 | 2.20 | −1.33 |
| 5 | 21 | ∞ | 0.00 | 0.00 | 0.00 |
| 6 | 22 | 229.88 | 6.58 | −4.40 | −8.51 |
| 7 | 25 | 49.16 | 79.17 | 11.15 | −44.33 |

### Fourth Numerical Embodiment

Surface Data

| Surface | | | | | Effective | Focal |
|---|---|---|---|---|---|---|
| Number | r | d | nd | vd | Diameter | Length |
| 1 | −608.314 | 2.50 | 1.85478 | 24.8 | 75.03 | −117.01 |
| 2 | 121.290 | 10.32 | 1 | | 72.52 | |
| 3 | 906.220 | 8.60 | 1.43387 | 95.1 | 72.66 | 235.90 |
| 4 | −115.378 | 0.10 | 1 | | 72.65 | |
| 5 | 109.863 | 11.72 | 1.53775 | 74.7 | 73.72 | 133.89 |
| 6 | −202.972 | 0.10 | 1 | | 73.51 | |
| 7 | 60.461 | 8.59 | 1.76385 | 48.5 | 68.30 | 120.49 |
| 8 | 163.838 | (Variable) | 1 | | 67.14 | |
| 9* | −793.506 | 1.00 | 2.00330 | 28.3 | 25.91 | −17.42 |
| 10 | 18.034 | 5.01 | 1 | | 21.71 | |
| 11 | −66.676 | 6.32 | 1.92286 | 18.9 | 21.53 | 20.94 |
| 12 | −15.818 | 0.80 | 1.88300 | 40.8 | 21.45 | −13.40 |
| 13 | 49.259 | 0.10 | 1 | | 21.01 | |
| 14 | 31.516 | 3.01 | 1.61293 | 37.0 | 21.21 | 51.96 |
| 15 | 1809.480 | (Variable) | 1 | | 21.07 | |
| 16 | −25.909 | 0.90 | 1.72000 | 43.7 | 19.22 | −19.18 |
| 17 | 30.346 | 2.78 | 1.84666 | 23.8 | 21.48 | 43.49 |
| 18 | 157.954 | (Variable) | 1 | | 21.94 | |
| 19* | 191.291 | 4.94 | 1.62041 | 60.3 | 25.43 | 48.00 |
| 20 | −35.084 | (Variable) | 1 | | 26.40 | |
| 21 (Stop) | ∞ | 1.20 | 1 | | 28.16 | |
| 22 | 62.753 | 8.43 | 1.54072 | 47.2 | 28.98 | 38.63 |
| 23 | −30.052 | 1.00 | 1.83481 | 42.7 | 29.02 | −60.44 |
| 24 | −74.828 | 32.00 | 1 | | 29.62 | |
| 25 | 38.591 | 7.44 | 1.49700 | 81.5 | 29.65 | 51.29 |
| 26 | −70.875 | 2.32 | 1 | | 28.83 | |
| 27 | −113.548 | 1.40 | 1.83403 | 37.2 | 26.86 | −29.10 |
| 28 | 31.296 | 6.81 | 1.48749 | 70.2 | 25.73 | 37.50 |
| 29 | −41.156 | 0.10 | 1 | | 25.58 | |
| 30 | 77.713 | 5.73 | 1.50127 | 56.5 | 24.81 | 42.16 |
| 31 | −28.478 | 1.40 | 1.88300 | 40.8 | 24.34 | −35.29 |
| 32 | −318.615 | 0.10 | 1 | | 24.37 | |
| 33 | 42.795 | 3.68 | 1.51742 | 52.4 | 24.26 | 86.40 |
| 34 | 883.153 | 4.00 | 1 | | 23.80 | |
| 35 | ∞ | 33.00 | 1.60859 | 46.4 | 40.00 | |
| 36 | ∞ | 13.20 | 1.51633 | 64.1 | 40.00 | |
| 37 | ∞ | | 1 | | 40.00 | |
| Image | ∞ | | | | | |
| Plane | | | | | | |

Aspherical Data
Ninth Surface

| | | |
|---|---|---|
| K = 1.19041e+003 | A4 = 4.10816e−006 | A6 = −3.65531e−009 |
| A8 = 1.05749e−010 | | |
| A10 = 1.05217e−012 | A12 = 1.09849e−014 | |
| A3 = −5.18592e−007 | A5 = 2.55009e−008 | A7 = −3.12764e−009 |
| A9 = 2.00615e−011 | A11 = −3.03481e−013 | |

Nineteenth Surface

| | | |
|---|---|---|
| K = 2.54389e+001 | A4 = −2.96191e−006 | A6 = 7.08826e−009 |
| A8 = −5.89298e−011 | | |
| A10 = 2.16013e−013 | A12 = −3.24859e−016 | |

Various Data
Zoom Ratio 17.95

| | Wide Angle | Middle | Telephoto |
|---|---|---|---|
| Focal Length | 7.80 | 10.89 | 140.01 |
| F-number | 1.80 | 1.80 | 2.20 |
| Half Angle of View | 35.19 | 26.79 | 2.25 |
| Image Height | 5.50 | 5.50 | 5.50 |
| Full Length of Lens | 260.08 | 260.08 | 260.08 |
| BF | 4.50 | 4.50 | 4.50 |
| d8 | 1.56 | 12.11 | 54.28 |
| d15 | 52.86 | 29.69 | 10.71 |
| d18 | 2.59 | 3.36 | 1.02 |
| d20 | 10.00 | 21.85 | 1.00 |

Focus Adjustment Variable Spacing Close Distance (0.6 m from surface
of first lens unit closest to object)

| | | | |
|---|---|---|---|
| d12 | 52.80 | 29.57 | 3.87 |
| d15 | 2.63 | 3.48 | 7.84 |
| Entrance Pupil Position | 43.30 | 61.39 | 611.06 |
| Exit Pupil Position | −701.88 | −701.88 | −701.88 |
| Front Principal Point | 51.01 | 72.11 | 723.32 |
| Position | | | |
| Rear Principal Point | −3.30 | −6.40 | −135.51 |
| Position | | | |

Zoom Lens Unit Data

| | | | | Front | |
|---|---|---|---|---|---|
| | | | Lens | Principal | |
| | Start | Focal | Configuration | Point | Rear Principal |
| Unit | Surface | Length | Length | Position | Point Position |
| 1 | 1 | 70.00 | 41.93 | 28.03 | 2.17 |
| 2 | 9 | −14.50 | 16.23 | 0.97 | −10.17 |
| 3 | 16 | −34.20 | 3.68 | 0.30 | −1.71 |
| 4 | 19 | 48.00 | 4.94 | 2.60 | −0.48 |
| 5 | 21 | ∞ | 0.00 | 0.00 | 0.00 |
| 6 | 22 | 100.32 | 9.43 | 1.39 | −4.71 |
| 7 | 25 | 51.13 | 79.16 | 8.07 | −46.58 |

### Fifth Numerical Embodiment

Surface Data

| Surface | | | | | Effective | Focal |
|---|---|---|---|---|---|---|
| Number | r | d | nd | vd | Diameter | Length |
| 1 | 6841.374 | 3.00 | 1.80610 | 40.9 | 116.58 | −261.51 |
| 2 | 205.613 | 0.19 | 1 | | 116.19 | |
| 3 | 199.348 | 16.16 | 1.43387 | 95.1 | 116.41 | 282.80 |
| 4 | −313.313 | 0.10 | 1 | | 116.62 | |
| 5 | 169.260 | 12.90 | 1.43387 | 95.1 | 116.38 | 405.54 |
| 6 | 4090.065 | 0.20 | 1 | | 115.69 | |
| 7 | 142.083 | 9.91 | 1.43387 | 95.1 | 112.09 | 556.56 |
| 8 | 336.694 | 0.20 | 1 | | 110.67 | |
| 9 | 118.797 | 9.53 | 1.43387 | 95.1 | 106.26 | 553.82 |
| 10 | 228.690 | (Variable) | 1 | | 104.24 | |
| 11 | 258.218 | 1.00 | 1.88300 | 40.8 | 38.46 | −29.14 |
| 12 | 23.481 | 9.27 | 1 | | 32.59 | |
| 13 | −61.429 | 1.00 | 1.81600 | 46.6 | 32.56 | −70.70 |
| 14 | 1042.705 | 0.10 | 1 | | 33.26 | |
| 15 | 45.828 | 6.89 | 1.80810 | 22.8 | 34.66 | 39.34 |
| 16 | −100.143 | 2.32 | 1 | | 34.36 | |
| 17 | −139.065 | 1.1 | 1.81600 | 46.6 | 32.68 | −71.77 |
| 18 | 102.422 | (Variable) | 1 | | 32.00 | |
| 19 | −41.207 | 1.30 | 1.71700 | 47.9 | 25.42 | −26.23 |
| 20 | 35.382 | 4.09 | 1.84666 | 23.8 | 27.59 | 54.38 |
| 21 | 140.164 | (Variable) | 1 | | 28.11 | |
| 22 | 235.063 | 5.41 | 1.60738 | 56.8 | 36.60 | 74.09 |
| 23 | −55.460 | 0.15 | 1 | | 37.13 | |
| 24 | 96.559 | 3.93 | 1.51823 | 58.9 | 37.89 | 143.33 |
| 25 | −322.996 | 0.35 | 1 | | 37.83 | |
| 26 | 38.426 | 9.12 | 1.53775 | 74.7 | 37.11 | 48.67 |
| 27 | −76.022 | 1.50 | 1.83400 | 37.2 | 36.13 | −38.43 |
| 28 | 56.526 | (Variable) | 1 | | 34.30 | |
| 29 | ∞ | 1.00 | 1 | | 34.29 | |
| (Stop) | | | | | | |
| 30 | 101.607 | 4.50 | 1.50137 | 56.4 | 34.29 | 98.19 |
| 31 | −94.862 | 1.50 | 1.88300 | 40.8 | 34.12 | −99.13 |
| 32 | 1233.129 | 50.00 | 1 | | 34.06 | |
| 33 | 106.721 | 5.71 | 1.57501 | 41.5 | 33.67 | 59.78 |
| 34 | −50.131 | 1.74 | 1 | | 33.48 | |
| 35 | −55.674 | 1.20 | 1.79952 | 42.2 | 31.96 | −73.63 |
| 36 | −943.423 | 4.42 | 1.51823 | 58.9 | 31.73 | 101.50 |
| 37 | −50.095 | 2.00 | 1 | | 31.55 | |
| 38 | 53.184 | 7.79 | 1.48749 | 70.2 | 28.23 | 42.29 |
| 39 | −32.227 | 1.20 | 1.83481 | 42.7 | 26.65 | −27.96 |
| 40 | 87.806 | 0.90 | 1 | | 25.53 | |
| 41 | 28.031 | 5.12 | 1.51823 | 58.9 | 25.06 | 78.09 |
| 42 | 84.729 | 3.80 | 1 | | 23.75 | |
| 43 | ∞ | 33.00 | 1.60859 | 46.4 | 40.00 | |
| 44 | ∞ | 13.20 | 1.51633 | 64.1 | 40.00 | |
| 45 | ∞ | | 1 | | 40.00 | |
| Image | ∞ | | | | | |
| Plane | | | | | | |

Various Data
Zoom Ratio 37.23

| | Wide Angle | Middle | Telephoto |
|---|---|---|---|
| Focal Length | 10.90 | 33.39 | 405.83 |
| F-number | 2.00 | 2.00 | 3.56 |
| Half Angle of View | 26.77 | 9.35 | 0.78 |
| Image Height | 5.50 | 5.50 | 5.50 |
| Full Length of Lens | 401.55 | 401.55 | 401.55 |
| BF | 14.00 | 14.00 | 14.00 |
| d10 | 2.97 | 67.96 | 125.54 |
| d18 | 125.85 | 51.07 | 18.53 |
| d21 | 11.98 | 16.99 | 2.00 |
| d28 | 9.93 | 14.71 | 4.66 |

Focus Adjustment Variable Spacing Close Distance (3.0 m from surface
of first lens unit closest to object)

| | | | |
|---|---|---|---|
| d18 | 125.83 | 50.85 | 4.26 |
| d21 | 12.00 | 17.20 | 16.26 |
| Entrance Pupil Position | 78.43 | 304.59 | 2991.48 |
| Exit Pupil Position | −508.65 | −508.65 | −508.65 |
| Front Principal Point | 89.10 | 335.84 | 3082.19 |
| Position | | | |
| Rear Principal Point | 3.10 | −19.38 | −391.83 |
| Position | | | |

Zoom Lens Unit Data

| | | | | Front | |
|---|---|---|---|---|---|
| | | | Lens | Principal | |
| | Start | Focal | Configuration | Point | Rear Principal |
| Unit | Surface | Length | Length | Position | Point Position |
| 1 | 1 | 170.00 | 52.18 | 20.03 | −15.49 |
| 2 | 11 | −26.34 | 21.68 | 2.25 | −13.56 |
| 3 | 19 | −50.00 | 5.39 | 0.76 | −2.16 |
| 4 | 22 | 50.00 | 20.47 | −3.47 | −14.48 |
| 5 | 29 | ∞ | 0.00 | 0.00 | 0.00 |
| 6 | 30 | 3976.18 | 6.00 | −59.17 | −62.05 |
| 7 | 33 | 65.15 | 80.08 | 2.32 | −51.08 |

### Sixth Numerical Embodiment

Surface Data

| Surface | | | | | Effective | Focal |
|---|---|---|---|---|---|---|
| Number | r | d | nd | vd | Diameter | Length |
| 1 | 1920.690 | 2.50 | 1.85478 | 24.8 | 85.04 | −160.32 |
| 2 | 128.970 | 6.64 | 1 | | 81.94 | |
| 3 | 332.528 | 9.70 | 1.43387 | 95.1 | 82.85 | 262.69 |
| 4 | −172.530 | 0.10 | 1 | | 83.38 | |
| 5 | 116.994 | 13.35 | 1.43387 | 95.1 | 85.64 | 192.40 |
| 6 | −283.772 | 0.10 | 1 | | 85.40 | |
| 7 | 69.002 | 10.72 | 1.76385 | 48.5 | 80.32 | 128.14 |
| 8 | 215.580 | (Variable) | 1 | | 79.17 | |
| 9* | 1578.603 | 1.00 | 2.00330 | 28.3 | 28.23 | −21.35 |
| 10 | 21.296 | 5.26 | 1 | | 23.84 | |
| 11 | −62.662 | 0.80 | 1.88300 | 40.8 | 23.53 | −25.72 |
| 12 | 36.152 | 0.14 | 1 | | 23.03 | |
| 13 | 31.208 | 4.95 | 1.95906 | 17.5 | 23.21 | 24.43 |
| 14 | −91.496 | 0.18 | 1 | | 22.78 | |
| 15 | −160.517 | 0.80 | 1.77250 | 49.6 | 22.42 | −44.41 |
| 16 | 43.996 | (Variable) | 1 | | 21.60 | |
| 17 | −28.909 | 0.90 | 1.75700 | 47.8 | 18.32 | −21.26 |
| 18 | 37.193 | 2.37 | 1.84666 | 23.8 | 20.06 | 50.77 |
| 19 | 252.136 | (Variable) | 1 | | 20.54 | |
| 20* | 59.789 | 5.20 | 1.64000 | 60.1 | 25.36 | 39.89 |
| 21 | −43.329 | (Variable) | 1 | | 26.06 | |
| 22 | ∞ | 1.00 | 1 | | 27.12 | |
| (Stop) | | | | | | |
| 23 | 416.688 | 4.65 | 1.50137 | 56.4 | 27.34 | 57.26 |
| 24 | −30.854 | 1.00 | 1.83481 | 42.7 | 27.45 | −92.99 |
| 25 | −51.774 | 1.00 | 1 | | 28.04 | |
| 26 | 38.814 | 6.22 | 1.49700 | 81.5 | 28.51 | 50.11 |
| 27 | −66.348 | 0.10 | 1 | | 28.13 | |
| 28 | 61.971 | 5.27 | 1.53172 | 48.8 | 26.52 | 46.11 |
| 29 | −39.677 | 0.90 | 1.80518 | 25.4 | 25.67 | −43.07 |
| 30 | 299.662 | 14.30 | 1 | | 24.69 | |
| 31 | −100.421 | 4.51 | 1.84666 | 23.8 | 18.16 | 30.65 |
| 32 | −21.211 | 0.70 | 1.83481 | 42.7 | 17.66 | −14.18 |
| 33 | 27.526 | 2.00 | 1 | | 16.96 | |
| 34 | 28.774 | 7.82 | 1.48749 | 70.2 | 28.08 | 44.15 |
| 35 | −78.838 | 2.38 | 1 | | 27.01 | |
| 36 | −141.385 | 1.00 | 1.88300 | 40.8 | 24.75 | −20.98 |
| 37 | 21.535 | 5.30 | 1.49700 | 81.5 | 23.32 | 36.18 |
| 38 | −101.786 | 0.10 | 1 | | 23.27 | |
| 39 | −275.321 | 4.11 | 1.51742 | 52.4 | 23.20 | 48.18 |
| 40 | −23.069 | 1.00 | 1.80100 | 35.0 | 23.31 | −47.19 |
| 41 | −59.718 | 0.10 | 1 | | 24.05 | |
| 42 | 47.66 | 3.62 | 1.56732 | 42.8 | 24.43 | 55.01 |
| 43 | −89.352 | 4.50 | 1 | | 24.30 | |
| 44 | ∞ | 33.00 | 1.60859 | 46.4 | 40.00 | |
| 45 | ∞ | 13.20 | 1.51633 | 64.1 | 40.00 | |
| 46 | ∞ | | 1 | | 40.00 | |
| Image | ∞ | | | | | |
| Plane | | | | | | |

Aspherical Data
Ninth Surface

| | | |
|---|---|---|
| K = −3.62925e+005 | A4 = 8.70252e−006 | A6 = −9.32479e−008 |
| A8 = 8.34598e−010 | A10 = −2.80575e−012 | A12 = 8.60704e−015 |
| A3 = −4.22396e−007 | A5 = 1.69179e−008 | A7 = −1.69005e−009 |
| A9 = 8.82958e−012 | A11 = −1.08793e−013 | |

Twentieth Surface

| | | |
|---|---|---|
| K = −2.19003e+000 | A4 = −5.55750e−006 | A6 = −4.88314e−009 |
| A8 = 1.46178e−010 | A10 = −8.99732e−013 | A12 = 1.90485e−015 |

Various Data
Zoom Ratio 21.78

| | Wide Angle | Middle | Telephoto |
|---|---|---|---|
| Focal Length | 15.29 | 60.78 | 332.97 |
| F-number | 3.53 | 3.53 | 4.20 |
| Half Angle of View | 19.78 | 5.17 | 0.95 |
| Image Height | 5.50 | 5.50 | 5.50 |
| Full Length of Lens | 264.27 | 264.27 | 264.27 |
| BF | 5.27 | 5.27 | 5.27 |
| d8 | 1.28 | 39.61 | 63.10 |
| d16 | 54.15 | 5.27 | 11.41 |
| d19 | 2.00 | 9.45 | 1.00 |
| d21 | 19.07 | 22.18 | 1.00 |

Focus Adjustment Variable Spacing Close Distance (0.9 m from surface
of first lens unit closest to object)

| | | | |
|---|---|---|---|
| d16 | 54.11 | 4.54 | 3.83 |
| d19 | 2.03 | 10.17 | 8.57 |
| Entrance Pupil Position | 48.56 | 180.67 | 872.34 |
| Exit Pupil Position | −103.82 | −103.82 | −103.82 |
| Front Principal Point | 61.70 | 207.59 | 189.01 |
| Position | | | |
| Rear Principal Point | −10.02 | −55.51 | −327.70 |
| Position | | | |

Zoom Lens Unit Data

| | | | | Front | Rear |
|---|---|---|---|---|---|
| | | | Lens | Principal | Principal |
| | Start | Focal | Configuration | Point | Point |
| Unit | Surface | Length | Length | Position | Position |
| 1 | 1 | 85.00 | 43.11 | 24.97 | −3.02 |
| 2 | 9 | −13.67 | 13.13 | 2.47 | −6.23 |
| 3 | 17 | −36.65 | 3.27 | 0.17 | −1.60 |
| 4 | 20 | 39.89 | 5.20 | 1.87 | −1.36 |
| 5 | 22 | ∞ | 0.00 | 0.00 | 0.00 |
| 6 | 23 | 151.56 | 5.65 | 3.87 | 0.23 |
| 7 | 26 | −112826.49 | 32.00 | 108380.62 | 55266.34 |
| 8 | 34 | 48.97 | 76.13 | 10.38 | −43.68 |

Table 1

TABLE 1
Conditional Expression Corresponding Values in First to Sixth Numerical
Embodiments

| Conditional | | | | | | | |
|---|---|---|---|---|---|---|---|
| Expression | Conditional | Numerical Embodiment | | | | | |
| Number | Expression | 1 | 2 | 3 | 4 | 5 | 6 |
| | fw | 7.800 | 7.800 | 7.900 | 7.800 | 10.900 | 15.290 |
| | f1 | 85.000 | 100.000 | 75.000 | 70.000 | 170.000 | 85.000 |
| | f2 | −13.666 | −14.316 | −13.672 | −14.500 | −26.339 | −13.666 |
| | f3 | −36.648 | −33.675 | −37.500 | −34.200 | −50.000 | −36.648 |
| | f4 | 39.886 | 40.059 | 40.306 | 48.000 | 50.000 | 39.886 |
| | β2w | −0.212 | −0.194 | −0.241 | −0.263 | −0.214 | −0.212 |
| | β2z | −0.521 | −0.347 | −0.299 | −0.325 | −0.454 | −0.521 |
| | φ1n | −0.006 | −0.005 | −0.006 | −0.009 | −0.004 | −0.006 |
| | φ1p | 0.017 | 0.015 | 0.018 | 0.020 | 0.010 | 0.017 |
| | D | 35.000 | 36.000 | 32.000 | 32.000 | 50.000 | — |
| | EA | 28.035 | 28.608 | 28.684 | 29.616 | 34.061 | — |
| | φ | 11.000 | 11.000 | 11.000 | 11.000 | 11.000 | 11.000 |
| (1) | fw × Z_{0.07} | 9.677 | 9.714 | 9.793 | 9.547 | 14.041 | 18.970 |
| | fz | 31.006 | 20.977 | 11.828 | 10.895 | 33.386 | 60.779 |
| | fw × Z_{0.5} | 36.399 | 37.409 | 36.631 | 33.047 | 66.510 | 71.352 |
| (2) | \|f1/f2\| | 6.220 | 6.985 | 5.486 | 4.828 | 6.454 | 6.220 |
| (3) | \|f1/f3\| | 2.319 | 2.970 | 2.000 | 2.047 | 3.400 | 2.319 |
| (4) | \|f1/f4\| | 2.131 | 2.496 | 1.861 | 1.458 | 3.400 | 2.131 |
| (5) | β2z/β2w/Z | 0.113 | 0.078 | 0.058 | 0.069 | 0.057 | 0.113 |
| (6) | φ1p × f1 | 1.429 | 1.458 | 1.356 | 1.401 | 1.633 | 1.429 |
| (7) | φ1n × f1 | −0.530 | −0.452 | −0.482 | −0.598 | −0.650 | −0.530 |
| (8) | θ | 0.029 | 0.369 | −0.306 | 0.025 | −0.262 | — |
| (9) | D/EA | 1.248 | 1.258 | 1.116 | 1.080 | 1.468 | — |
| (10) | fw/φ | 0.709 | 0.709 | 0.718 | 0.709 | 0.991 | 1.390 |
| (11) | Z | 21.777 | 23.001 | 21.500 | 17.950 | 37.232 | 21.777 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-220300, filed Oct. 29, 2014, which is hereby incorporated by reference herein in its entirety.

What is claimed is:

1. A zoom lens comprising, from an object side to an image side:
a first lens unit having a positive refractive power that does not move for zooming;
a second lens unit having a negative refractive power that moves during zooming;
a third lens unit having a negative refractive power that moves during zooming;
a fourth lens unit having a positive refractive power that moves during zooming; and
a fifth lens unit having a positive refractive power, wherein
wherein the second lens unit moves from the object side to the image side during zooming from a wide angle end to a telephoto end, the third lens unit moves from the image side to the object side during focus adjustment from infinity to a close distance, and
wherein the following conditional expressions are satisfied:
fw×Z^{0.07}<fz<fw×Z^{0.5};
4.00<|f1/f2|<7.50;
2.00≦|f1/f3|<4.00; and
0.90<|f1/f4|<4.00,
where fw represents a focal length of the zoom lens at the wide angle end, Z represents a zoom ratio, fz represents a focal length of the zoom lens at a zoom position where the third lens unit is positioned closest to the object, f1 represents a focal length of the first lens unit, f2 represents a focal length of the second lens unit, f3 represents a focal length of the third lens unit, and f4 represents a focal length of the fourth lens unit.

2. The zoom lens according to claim 1, wherein
0.03β2z/β2w/Z<0.15
is satisfied where β2w and β2z respectively represent an imaging magnification at the wide angle end of the second lens unit and an imaging magnification at the zoom position of fz when the infinity is focused.

3. The zoom lens according to claim 1, wherein
1.00<φ1p×f1<2.00
−0.90<φ1n×f1<−0.20
are satisfied where φ1p represents an average power of a positive lens of the first lens unit and φ1n represents an average power of a negative lens of the first lens unit.

4. The zoom lens according to claim 1, wherein the first lens unit includes four or five lenses.

5. The zoom lens according to claim 1 further comprising an aperture stop,
wherein the lens unit disposed in the image side of the aperture stop does not move for zooming.

6. The zoom lens according to claim 1, wherein the aperture stop is positioned between the fourth lens unit and the fifth lens unit.

7. The zoom lens according to claim 1, wherein the fifth lens unit comprises: a first sub lens unit having a positive refractive power and a second sub lens unit having a positive refractive power separated from the first sub lens unit by an air space on an optical axis, the air space being largest in the fifth lens unit; and a focal length conversion optical system that can be inserted to and removed from an optical path between the first sub lens unit and the second sub lens unit, and
−3.0°<θ<+3.0°
is satisfied where θ represents an inclination angle formed by an axial ray passing through the air space between the first sub lens unit and the second sub lens unit relative to the optical axis at the wide angle end.

8. The zoom lens according to claim 1, wherein
0.50<D/EA<3.00
is satisfied where EA represents an optical effective diameter of a final lens surface of the first sub lens unit, and D is a length of the air space on the optical axis between the first sub lens unit and the second sub lens unit.

9. An image pickup apparatus comprising:
a zoom lens comprising, from an object side to an image side:
a first lens unit having a positive refractive power that does not move for zooming;
a second lens unit having a negative refractive power that moves during zooming;
a third lens unit having a negative refractive power that moves during zooming;
a fourth lens unit having a positive refractive power that moves during zooming; and
a fifth lens unit having a positive refractive power, wherein
wherein the second lens unit moves from the object side to the image side during zooming from a wide angle end to a telephoto end, the third lens unit moves from the image side to the object side during focus adjustment from infinity to a close distance, and
wherein the following conditional expressions are satisfied:
fw×Z^{0.07}<fz<fw×Z^{0.5};
4.00<|f1/f2|<7.50;
2.00≦|f1/f3|<4.00; and
0.90<|f1/f4|<4.00,
where fw represents a focal length of the zoom lens at the wide angle end, Z represents a zoom ratio, fz represents a focal length of the zoom lens at a zoom position where the third lens unit is positioned closest to the object, f1 represents a focal length of the first lens unit, f2 represents a focal length of the second lens unit, f3 represents a focal length of the third lens unit, and f4 represents a focal length of the fourth lens unit; and
an image pickup element that receives an image formed by the zoom lens.

10. The image pickup apparatus according to claim 9, wherein conditions
0.45<fw/φ
7.00<Z
are satisfied where φ represents a diagonal length of an image size of the image pickup element.
